(19) United States
(12) Patent Application Publication
(10) Pub. No.: US 2025/0271612 A1
(43) Pub. Date: Aug. 28, 2025

(54) HOLLOW CORE OPTICAL FIBER, HOLLOW CORE OPTICAL FIBER PREFORM, AND METHOD OF MAKING THE SAME

(71) Applicant: CORNING INCORPORATED, CORNING, NY (US)

(72) Inventors: Richard Michael Fiacco, Corning, NY (US); Sushmit Sunil Kumar Goyal, Painted Post, NY (US); Ming-Jun Li, Horseheads, NY (US); Pushkar Tandon, Painted Post, NY (US); Matthew Artus Tuggle, Seattle, WA (US)

(21) Appl. No.: 19/044,928

(22) Filed: Feb. 4, 2025

Related U.S. Application Data
(60) Provisional application No. 63/557,820, filed on Feb. 26, 2024.

(51) Int. Cl. G02B 6/032; C03B 37/012; C03B 37/014

(52) U.S. Cl. CPC G02B 6/032; C03B 37/0122; C03B 37/01446; C03B 37/01453; C03B 2201/12; C03B 2201/24; C03B 2201/40; C03B 2203/16

(57) ABSTRACT

A method of manufacturing a hollow core optical fiber including a vapor deposition step comprising vapor depositing a silica soot coating from one or more source materials over an outer surface of a cladding substrate tube of a workpiece that further includes capillary tubes disposed within a cavity of the cladding substrate tube. The compositions of the capillary tubes, the cladding substrate tube, and the silica soot coating can be manipulated with one or more viscosity-raising dopants or one or more viscosity-lowering dopants, or neither, to achieve a desired compositional profile of a hollow core optical fiber preform with a cladding consolidated from the silica soot coating of the workpiece. The desired composition profile results in a viscosity profile that prevents the capillary tubes from contacting each other during a drawing step performed upon the hollow core optical fiber preform.

This Application claims the benefit of priority to U.S. Provisional Patent Application Ser. No. 63/557,820 filed on Feb. 26, 2024, the content of which is relied upon and incorporated herein by reference in its entirety.

### TECHNICAL FIELD

The present disclosure pertains to hollow core optical fibers, hollow core optical fiber preforms with capillary tubes, methods of making the same and, in particular, to manipulating the concentration of viscosity-altering dopants within the compositions of the hollow core optical fiber preforms to achieve viscosity profiles as a function of radius that provide manufacturing benefits.

### BACKGROUND

An optical fiber is an optical waveguide that can be used to transmit electromagnetic radiation over long distances. The optical fiber typically includes a core and a cladding that surrounds the core. The electromagnetic radiation transmits through the core. The cladding serves to maintain the electromagnetic radiation within the core via internal reflection. Typically, the core of the optical fiber is made of a solid material such as a glass or a plastic (called a “solid core”).

In theory, an optical fiber that includes a core made of gas material (called a “hollow core”), rather than a solid material, would improve the ability of the optical fiber to transmit the electromagnetic radiation. That is because a hollow core, due to the absence of solid material, should be less able to scatter and absorb the electromagnetic radiation than a solid core. In addition, hollow core optical fibers can be designed to use photonic bandgap effect or anti-resonant effect to maintain the electromagnetic radiation within the core during transmission.

Hollow core optical fibers that rely on the latter (called “anti-resonant fibers” or “ARFs” for short) include a cladding with a cavity disposed around a longitudinal axis of the optical fiber and capillary tubes disposed within the cavity arranged around the longitudinal axis of the optical fiber. Making such hollow core optical fibers with the capillary tubes is difficult and the manufacturing difficulty has prevented widespread commercial application. To manufacture such a hollow core optical fiber, a preform is generated and then the optical fiber is drawn therefrom. During the draw, pressure is typically applied within the cavity of the cladding and within cavities of each of the capillary tubes. The applied pressure helps maintain the spatial relationships and dimensions of those components. However, the applied pressure can additionally cause undesirable expansion of the cladding and the capillary tubes, especially as draw temperature increases and the viscosity of those components consequently decreases. Reducing draw speed and increasing the tension during the draw can help prevent the undesirable expansion of the cladding and the capillary tubes.

However, those approaches lead to additional problems in that (i) reducing draw speed reduces the length of anti-resonant fiber that can be drawn within a predetermined period of time (thus increasing time and cost to manufacture the hollow core optical fiber) and (ii) increasing the tension during draw adds difficulty to cabling (e.g., applying a cable sheath over) the hollow core optical fiber. There is a further problem in that the capillary tubes tend to contact each other during draw and fuse together, which leads to failure of the resulting hollow core optical fiber.

### SUMMARY

The present disclosure addresses those problems with a hollow core optical fiber preform where the concentration of one or more viscosity-raising dopants and/or one or more viscosity-lowering dopants for silica glass is manipulated for the capillary tubes and the cladding as a function of radius from a longitudinal axis of the hollow core optical fiber preform. The concentration is manipulated so that the hollow core optical fiber preform exhibits a predetermined viscosity profile as a function of radius during a drawing step. The predetermined viscosity profile has an outer region of the cladding exhibiting a viscosity that is less than a viscosity that the capillary tubes exhibits. An inner region of the cladding can exhibit a viscosity that is greater than the viscosities that the outer region of the cladding and the capillary tubes exhibit.

According to a first aspect of the present disclosure, a hollow core optical fiber comprises: (a) a cladding disposed radially around a longitudinal axis of the hollow core optical fiber, the cladding extending along the longitudinal axis from a first end to a second end and comprising (i) an inner surface forming a cavity, (ii) an inner region extending outward from the inner surface relative to the longitudinal axis, the inner region comprising silica glass, and (iii) an outer region extending outward relative to the inner region, the outer region comprising silica glass; (b) capillary tubes disposed within the cavity of the cladding proximate to the inner surface of the cladding, each of the capillary tubes comprising (i) a longitudinal axis extending parallel to the longitudinal axis of the hollow core optical fiber, (ii) an outer surface fused to the inner surface of the cladding, and (iii) silica glass; and (c) an effective core region defined by the outer surfaces of the capillary tubes, wherein, at a temperature of 1800° C., the inner region of the cladding exhibits a viscosity that is greater than (i) a viscosity that the outer region of the cladding exhibits and (ii) viscosities that each of the capillary tubes exhibit, and wherein, the silica glasses of the inner region of the cladding, the outer region of the cladding, and the capillary tubes are each individually doped with one or more viscosity-lowering dopants, doped with one or more viscosity-raising dopants, or substantially free of both viscosity-lowering dopants and viscosity-raising dopants.

According to a second aspect of the present disclosure, the one or more viscosity-raising dopants is chosen from a group consisting of N and ZrO₂.

According to a third aspect of the present disclosure, the hollow core optical fiber of the second aspect is presented, wherein the one or more viscosity-raising dopants is or includes N.

According to a fourth aspect of the present disclosure, the hollow core optical fiber of any one of the first through third aspects is presented, wherein the one or more viscosity-lowering dopants is chosen from a group consisting of an alkali metal oxide, fluorine, chlorine, germania, titania, boron, and Al₂O₃.

According to a fifth aspect of the present disclosure, the hollow core optical fiber of any one of the first through fourth aspects is presented, wherein a distance separates the outer surfaces of adjacent capillary tubes.

According to a sixth aspect of the present disclosure, the hollow core optical fiber of any one of the first through fifth aspects is presented, wherein the hollow core optical fiber comprises from four to seven of the capillary tubes.

According to a seventh aspect of the present disclosure, the hollow core optical fiber of the sixth aspect is presented, wherein the hollow core optical fiber comprises six of the capillary tubes.

According to an eighth aspect of the present disclosure, the hollow core optical fiber of any one of the first through seventh aspects is presented, wherein the cladding further comprises an interfacial region disposed between the inner region and the outer region, the interfacial region comprising silica glass that is doped with both the one or more viscosity-raising dopants and the one or more viscosity-lowering dopants.

According to a ninth aspect of the present disclosure, the hollow core optical fiber of any one of the first through eighth aspects is presented, wherein (i) the silica glass of the outer region of the cladding is doped with the one or more viscosity-lowering dopants, and (ii) concentration of the one or more viscosity-lowering dopants doping the silica glass of the outer region of the cladding increases as radius from the longitudinal axis of the hollow core optical fiber increases, throughout an entirety of the outer region.

According to a tenth aspect of the present disclosure, the hollow core optical fiber of the ninth aspect is presented, wherein the concentration of the one or more viscosity-lowering dopants doping the silica glass of the outer region increases linearly as the radius from the longitudinal axis of the hollow core optical fiber increases, throughout an entirety of the outer region.

According to an eleventh aspect of the present disclosure, the hollow core optical fiber of any one of the first through eighth aspects is presented, wherein (a) the silica glass of the outer region of the cladding is doped with the one or more viscosity-lowering dopants, and (b) concentration of the one or more viscosity-lowering dopants doping the silica glass of the outer region of the cladding (i) is substantially constant as a function of radius from the longitudinal axis of the hollow core optical fiber throughout a first portion and (ii) changes as a function of radius from the longitudinal axis of the hollow core optical fiber throughout a second portion, the second portion being further from the longitudinal axis than the first portion.

According to a twelfth aspect of the present disclosure, the hollow core optical fiber of any one of the first through eleventh aspects is presented, wherein the silica glass of the capillary tubes is substantially free of both the viscosity-lowering dopants and the viscosity-raising dopants.

According to a thirteenth aspect of the present disclosure, the hollow core optical fiber of any one of the first through eleventh aspects is presented, wherein the silica glass of each of the capillary tubes is doped with the one or more viscosity-lowering dopants.

According to a fourteenth aspect of the present disclosure, the hollow core optical fiber of any one of the first through thirteenth aspects is presented, wherein at the temperature of 1800° C., the viscosity of each of the capillary tubes is greater than the viscosity that the outer region of the cladding exhibits.

According to a fifteenth aspect of the present disclosure, the hollow core optical fiber of any one of the first through fourteenth aspects further comprises inner capillary tubes, each of the inner capillary tubes (i) nested within a different one of the capillary tubes with an outer surface of the inner capillary tube fused to an inner surface of the capillary tube and (ii) comprising a longitudinal axis extending parallel to the longitudinal axis of the hollow core optical fiber.

According to a sixteenth aspect of the present disclosure, the hollow core optical fiber of the fifteenth aspect is presented, wherein each of the inner capillary tubes comprises silica glass that is doped with the one or more viscosity-lowering dopants, doped with the one or more viscosity-raising dopants, or substantially free of both viscosity-lowering dopants and viscosity-raising dopants.

According to a seventeenth aspect of the present disclosure, the hollow core optical fiber of any one of the fifteenth through sixteenth aspects is presented, wherein at the temperature of 1800° C., the viscosity that the inner region of the cladding exhibits is greater than viscosity that each of the inner capillary tubes exhibits, with (i) the viscosity that each of the inner capillary tubes exhibits being greater than the viscosity that each of the capillary tubes exhibits and (ii) the viscosity that each of the capillary tubes and the viscosity each of the inner capillary tubes exhibit being greater than the viscosity that the outer region of the cladding exhibits.

According to an eighteenth aspect of the present disclosure, the hollow core optical fiber of any one of the first through seventeenth aspects is presented, wherein each of the capillary tubes exhibits a softening point that is at least 30° C. greater than a softening point that the cladding exhibits.

According to a nineteenth aspect of the present disclosure, the hollow core optical fiber of any one of the first through seventeenth aspects is presented, wherein each of the capillary tubes exhibits a softening point that is at least 50° C. greater than a softening point that the cladding exhibits.

According to a twentieth aspect of the present disclosure, the hollow core optical fiber of any one of the first through seventeenth aspects is presented, wherein each of the capillary tubes exhibits a softening point that is at least 100° C. greater than a softening point that the cladding exhibits.

According to a twenty-first aspect of the present disclosure, the hollow core optical fiber of any one of the first through twentieth aspects is presented, wherein the silica glass of the outer region of the cladding is doped with fluorine as the one or more viscosity-lowering dopants at an average concentration of greater than 0.3 wt %.

According to a twenty-second aspect of the present disclosure, the hollow core optical fiber of any one of the first through twentieth aspects is presented, wherein the silica glass of the outer region of the cladding is doped with fluorine as the one or more viscosity-lowering dopants at an average concentration of greater than 0.6 wt %.

According to a twenty-third aspect of the present disclosure, the hollow core optical fiber of any one of the first through twenty-second aspects further comprises an outer tension absorbing layer disposed radially around the longitudinal axis of the hollow core optical fiber outward of the outer region of the cladding, the outer tension absorbing layer (i) comprising silica glass and (ii) at a temperature of 1800° C., exhibiting a viscosity that is greater than the viscosity that the outer region of the cladding exhibits and the viscosity that each of the capillary tube exhibits.

According to a twenty-fourth aspect of the present disclosure, the hollow core optical fiber of the twenty-third aspect is presented, wherein the inner region of the cladding exhibits an axial stress that is less than 60 MPa.

According to a twenty-fifth aspect of the present disclosure, a hollow core optical fiber preform comprises: (a) a cladding disposed radially around a longitudinal axis of the hollow core optical fiber preform, the cladding extending along the longitudinal axis from a first end to a second end and comprising (i) an inner surface forming a cavity, (ii) an inner region extending outward from the inner surface relative to the longitudinal axis, the inner region comprising silica glass, and (iii) an outer region extending outward relative to the inner region, the outer region comprising silica glass; and (b) capillary tubes disposed within the cavity of the cladding proximate to the inner surface of the cladding, each of the capillary tubes comprising (i) a longitudinal axis extending parallel to the longitudinal axis of the hollow core optical fiber preform, (ii) an outer surface fused to the inner surface of the cladding, and (iii) silica glass, wherein, at a temperature of 1800° C., the inner region of the cladding exhibits a viscosity that is greater than (i) a viscosity that the outer region of the cladding exhibits and (ii) a viscosity that each of the capillary tubes exhibits, and wherein, the silica glasses of the inner region of the cladding, the outer region of the cladding, and the capillary tubes are each individually doped with one or more viscosity-lowering dopants, doped with one or more viscosity-raising dopants, or substantially free of both viscosity-lowering dopants and viscosity-raising dopants.

According to a twenty-sixth aspect of the present disclosure, the hollow core optical fiber preform of the twenty-fifth aspect further comprises: one or more support tubes disposed around the longitudinal axis of the hollow core optical fiber preform and closer to the longitudinal axis of the hollow core optical fiber preform than the capillary tubes; wherein, each of the capillary tubes is fused to each of the one or more support tubes.

According to a twenty-seventh aspect of the present disclosure, the hollow core optical fiber preform of the twenty-sixth aspect is presented, wherein each of the one or more capillary tubes is fused to the substrate tube proximate one or both of the first end and the second end of the substrate tube.

According to a twenty-eighth aspect of the present disclosure, the hollow core optical fiber preform of any one of the twenty-sixth through twenty-seventh aspects is presented, wherein (a) each of the one or more support tubes comprises (i) a first end, (ii) a second end, and (iii) a length parallel to the longitudinal axis of the hollow core optical fiber preform and that extends between the first end and the second end of the support tube, (b) the cladding further comprises a length parallel to the hollow core optical fiber preform between the first end and the second end of the substrate tube, and (c) the length of the one or more support tubes combined is less than the length of the cladding.

According to a twenty-ninth aspect of the present disclosure, the hollow core optical fiber preform of any one of the twenty-fifth through twenty-seventh aspects further comprises: inner capillary tubes, each of the inner capillary tubes (i) nested within a different one of the capillary tubes with an outer surface of the inner capillary tube fused to an inner surface of the capillary tube and (ii) comprising a longitudinal axis extending parallel to the longitudinal axis of the hollow core optical fiber preform, wherein, each of the inner capillary tubes comprises silica glass that is doped with the one or more viscosity-raising dopants, doped with one or more viscosity-lowering dopants, or substantially free of both the viscosity-lowering dopants and the viscosity-raising dopants.

According to a thirtieth aspect of the present disclosure, the hollow core optical fiber preform of the twenty-ninth aspect is presented, wherein at the temperature of 1800° C., the viscosity that the inner region of the cladding exhibits is greater than the viscosity that each of the inner capillary tubes exhibits, with (i) the viscosity that each of the inner capillary tubes exhibits being greater than the viscosity that each of the capillary tubes exhibits and (ii) the viscosity that each of the capillary tubes and the viscosity that each of the inner capillary tubes exhibits being greater than the viscosity that the outer region of the cladding exhibits.

According to a thirty-first aspect of the present disclosure, the hollow core optical fiber preform of any one of the twenty-ninth through thirtieth aspects is presented, wherein each of the inner capillary tubes exhibits a softening point that is at least 30° C. greater than a softening point that the cladding exhibits.

According to a thirty-second aspect of the present disclosure, the hollow core optical fiber preform of any one of the twenty-fifth through thirty-first aspects is presented, wherein the one or more viscosity-raising dopants is chosen from a group consisting of N and ZrO₂.

According to a thirty-third aspect of the present disclosure, the hollow core optical fiber preform of the thirty-second aspect is presented, wherein the one or more viscosity-raising dopants is or includes N.

According to a thirty-fourth aspect of the present disclosure, the hollow core optical fiber preform of any one of the twenty-fifth through thirty-third aspects is presented, wherein the one or more viscosity-lowering dopants is chosen from a group consisting of an alkali metal oxide, fluorine, chlorine, germania, titania, boron, and Al₂O₃.

According to a thirty-fifth aspect of the present disclosure, the hollow core optical fiber preform of any one of the twenty-fifth through thirty-fourth aspects is presented, wherein a distance separates the outer surfaces of adjacent capillary tubes.

According to a thirty-sixth aspect of the present disclosure, the hollow core optical fiber preform of any one of the twenty-fifth through thirty-fifth aspects is presented, wherein the hollow core optical fiber comprises from four to seven of the capillary tubes.

According to a thirty-seventh aspect of the present disclosure, the hollow core optical fiber preform of the thirty-sixth aspect is presented, wherein the hollow core optical fiber comprises six of the capillary tubes.

According to a thirty-eighth aspect of the present disclosure, the hollow core optical fiber preform of any one of the twenty-fifth through thirty-seventh aspects is presented, wherein the cladding further comprises an interfacial region disposed between the inner region and the outer region, the interfacial region comprising silica glass that is doped with both the one or more viscosity-raising dopants and the one or more viscosity-lowering dopants.

According to a thirty-ninth aspect of the present disclosure, the hollow core optical fiber preform of any one of the twenty-fifth through thirty-eighth aspects is presented, wherein (a) the silica glass of the outer region of the cladding is doped with the one or more viscosity-lowering dopants, and (b) concentration of the one or more viscosity-lowering dopants of the composition of the outer region of the cladding increases as radius from the longitudinal axis of the hollow core optical fiber increases, throughout an entirety of the outer region.

According to a fortieth aspect of the present disclosure, the hollow core optical fiber preform of any one of the twenty-fifth through thirty-eighth aspects is presented, wherein (a) the silica glass of the outer region of the cladding is doped with the one or more viscosity-lowering dopants, and (b) concentration of the one or more viscosity-lowering dopants of the composition of the outer region increases linearly as the radius from the longitudinal axis of the hollow core optical fiber increases, throughout an entirety of the outer region.

According to a forty-first aspect of the present disclosure, the hollow core optical fiber preform of any one of the twenty-fifth through thirty-eighth aspects is presented, wherein (a) the silica glass of the outer region of the cladding is doped with the one or more viscosity-lowering dopants, and (b) concentration of the one or more viscosity-lowering dopants of the composition of the outer region of the cladding (i) is substantially constant as a function of the radius from the longitudinal axis of the hollow core optical fiber throughout a first portion and (ii) changes as a function of the radius from the longitudinal axis of the hollow core optical fiber throughout a second portion, the second portion being further from the longitudinal axis than the first portion.

According to a forty-second aspect of the present disclosure, the hollow core optical fiber preform of any one of the twenty-fifth through forty-first aspects is presented, wherein the silica glass of the capillary tubes is substantially free of both the viscosity-lowering dopants and the viscosity-raising dopants.

According to a forty-third aspect of the present disclosure, the hollow core optical fiber preform of any one of the twenty-fifth through forty-first aspects is presented, wherein the silica glass of each of the capillary tubes is doped with the one or more viscosity-lowering dopants.

According to a forty-fourth aspect of the present disclosure, the hollow core optical fiber preform of any one of the twenty-fifth through forty-third aspects is presented, wherein at a temperature of 1800° C., the viscosity of each of the capillary tubes is greater than the viscosity that the outer region of the cladding exhibits.

According to a forty-fifth aspect of the present disclosure, the hollow core optical fiber preform of any one of the twenty-ninth through thirty-first aspects is presented, wherein at a temperature of 1800° C., the viscosity that the inner region of the cladding exhibits is greater than a viscosity that each of the inner capillary tubes exhibits, with (i) the viscosity that each of the inner capillary tubes exhibits being greater than the viscosity that each of the capillary tubes exhibits and (ii) the viscosity that each of the capillary tubes and the viscosity that each of the inner capillary tubes exhibits being greater than the viscosity that the outer region of the cladding exhibits.

According to a forty-sixth aspect of the present disclosure, the hollow core optical fiber preform of any one of the twenty-ninth through forty-fifth aspects is presented, wherein each of the capillary tubes exhibits a softening point that is at least 30° C. greater than a softening point that the cladding exhibits.

According to a forty-seventh aspect of the present disclosure, the hollow core optical fiber preform of any one of the twenty-ninth through forty-sixth aspects is presented, wherein the silica glass of the outer region of the cladding is doped with fluorine as the one or more viscosity-lowering dopants at an average concentration of greater than 0.3 wt %.

According to a forty-eighth aspect of the present disclosure, a method of manufacturing a hollow core optical fiber comprises: with a workpiece comprising: (a) a cladding substrate tube comprising (i) a longitudinal axis, (ii) an inner surface forming a cavity, (iii) an outer surface, and (iv) silica glass and (b) capillary tubes disposed within the cavity of the cladding substrate tube proximate the inner surface of the cladding substrate tube, each of the capillary tubes comprising (i) a longitudinal axis parallel to the longitudinal axis of the cladding substrate tube, (ii) an inner surface forming a cavity, and (iii) silica glass, a vapor deposition step comprising vapor depositing a silica soot coating from one or more source materials over the outer surface of the cladding substrate tube.

According to a forty-ninth aspect of the present disclosure, the method of the forty-eighth aspect is presented, wherein the workpiece further comprises inner capillary tubes, each of which is disposed within the cavity of a different one of the capillary tubes, each of the inner capillary tubes comprising (i) a longitudinal axis parallel to the longitudinal axis of the cladding substrate tube, (ii) an inner surface forming a cavity, and (iii) silica glass.

According to a fiftieth aspect of the present disclosure, the method of any one of the forty-eighth through forty-ninth aspects is presented, wherein during the vapor deposition step, source material for silica glass is vaporized and oxidized to form a silica-containing soot stream that is directed to the workpiece to form a preform that comprises the workpiece with a silica soot coating.

According to a fifty-first aspect of the present disclosure, the method of the fiftieth aspect is presented, wherein (i) during the vapor deposition step, source material for one or more viscosity-lowering dopants is vaporized and introduced into the silica-containing soot stream that is directed to the workpiece, and (ii) the silica soot coating further comprises the one or more viscosity-lowering dopants.

According to a fifty-second aspect of the present disclosure, the method of the fifty-first aspect is presented, wherein the one or more viscosity-lowering dopants are chosen from a group consisting of an alkali metal oxide, fluorine, chlorine, germania, titania, boron, and Al₂O₃.

According to a fifty-third aspect of the present disclosure, the method of any one the fifty-first through fifty-second aspects is presented, wherein the source material for the one or more viscosity-lowering dopants comprises SiF₄.

According to a fifty-fourth aspect of the present disclosure, the method of any one the fifty-first through fifty-third aspects is presented, wherein a mass flow ratio of the source material for the one or more viscosity-lowering dopants to the source material for the silica glass is changed during the vapor deposition step.

According to a fifty-fifth aspect of the present disclosure, the method of any one the fifty-first through fifty-fourth aspects is presented, wherein the ratio of the source material for the one or more viscosity-lowering dopants to the source material for the silica glass increases as a function of time throughout substantially an entirety of the vapor deposition step.

According to a fifty-sixth aspect of the present disclosure, the method of any one the fifty-first through fifty-fourth aspects is presented, wherein the ratio of the source material for the one or more viscosity-lowering dopants to the source material for the silica glass (i) is substantially constant for a first period of time and (ii) then changes throughout a second period of time.

According to a fifty-seventh aspect of the present disclosure, the method of any one of the forty-eighth through fifty-sixth aspects further comprises: a consolidation step comprising consolidating the soot preform, thus forming a hollow core optical fiber preform comprising: (a) a cladding disposed radially around a longitudinal axis of the hollow core optical fiber preform, the cladding extending along the longitudinal axis from a first end to a second end and comprising (i) an inner surface and (ii) silica glass; and (b) capillary tubes disposed within the cladding proximate to the inner surface of the cladding, each of the capillary tubes comprising (i) a longitudinal axis extending parallel to the longitudinal axis of the hollow core optical fiber preform, (ii) an outer surface fused to the inner surface of the cladding, and (iii) silica glass.

According to a fifty-eighth aspect of the present disclosure, the method of the fifty-seventh aspect is presented, wherein the consolidation step further comprises subjecting the soot preform to an atmosphere comprising a gas of one or more viscosity-lowering dopants.

According to a fifty-ninth aspect of the present disclosure, the method of any one of the forty-eighth through fifty-eighth aspects further comprises: a drawing step comprising (i) subjecting the hollow core optical fiber preform to a draw temperature, (ii) pressurizing the cavity of each of the capillary tubes and the cavity of the cladding, and (iii) drawing a hollow core optical fiber from the hollow core optical fiber preform.

According to a sixtieth aspect of the present disclosure, the method of the fifty-ninth aspect is presented, wherein during the drawing step, the hollow core optical fiber is drawn from the hollow core optical fiber preform at a draw tension that is less than or equal to 200 grams.

According to a sixty-first aspect of the present disclosure, the method of the fifty-ninth aspect is presented, wherein during the drawing step, the hollow core optical fiber is drawn from the hollow core optical fiber preform at a draw tension that is less than or equal to 100 grams.

According to a sixty-second aspect of the present disclosure, the method of any one of the fifty-ninth through sixty-first aspects is presented, wherein during the drawing step, at least a portion of the cladding of the hollow core optical fiber preform exhibits a viscosity that is less than a viscosity that each of the capillary tubes exhibits.

According to a sixty-third aspect of the present disclosure, the method of any one of the fifty-ninth through sixty-second aspects is presented, wherein during the drawing step, an inner region of the cladding of the hollow core optical fiber preform that is contiguous with the inner surface of the cladding of the hollow core optical fiber preform exhibits a viscosity that is greater than a viscosity that an outer region of the cladding of the of the hollow core optical fiber preform disposed outward from the inner region exhibits.

According to a sixty-fourth aspect of the present disclosure, the method of any one of the fifty-ninth through sixty-first aspects is presented, wherein during the drawing step, an inner region of the cladding of the hollow core optical fiber extending contiguous with the inner surface of the cladding exhibits a viscosity that is greater than both (i) a viscosity that an outer region of the cladding of the hollow core optical fiber disposed outward from the inner region exhibits and (ii) a viscosity that the capillary tubes of the hollow core optical fiber exhibits.

According to a sixty-fifth aspect of the present disclosure, the method of any one of the fifty-ninth through sixty-fourth aspects is presented, wherein during the drawing step, the viscosity that each of the capillary tubes of the hollow core optical fiber exhibits is greater than the viscosity that the outer region of the cladding of the hollow core optical fiber exhibits.

According to a sixty-sixth aspect of the present disclosure, the method of any one of the fifty-ninth through sixty-fifth aspects is presented, wherein during the drawing step, the viscosity that the outer region of the cladding of the hollow core optical fiber preform exhibits (i) is substantially constant throughout a first portion and (ii) changes as a function of radius from the longitudinal axis of the hollow core optical fiber throughout a second portion, the second portion being further from the longitudinal axis than the first portion.

According to a sixty-seventh aspect of the present disclosure, the method of any one of the fifty-ninth through sixty-fifth aspects is presented, wherein during the drawing step, the viscosity that the outer region of the cladding of the hollow core optical fiber exhibits decreases as the radius from the longitudinal axis of the hollow core optical fiber increases, throughout an entirety of the outer region.

According to a sixty-eighth aspect of the present disclosure, the method of any one of the fifty-ninth through sixty-seventh aspects is presented, wherein during the drawing step, the hollow core optical fiber is drawn from the hollow core optical fiber preform at a draw speed of greater than or equal to 1 m/s.

According to a sixty-ninth aspect of the present disclosure, the method of the sixty-eighth aspect is presented, wherein during the drawing step, the hollow core optical fiber is drawn from the hollow core optical fiber preform at a draw speed of greater than or equal to 5 m/s.

According to a seventieth aspect of the present disclosure, a hollow core optical fiber comprises: (a) a cladding disposed radially around a longitudinal axis of the hollow core optical fiber, the cladding extending along the longitudinal axis from a first end to a second end and comprising (i) an inner surface forming a cavity, (ii) an inner region extending outward from the inner surface relative to the longitudinal axis, the inner region comprising silica glass, and (iii) an outer region extending outward relative to the inner region, the outer region comprising silica glass; (b) capillary tubes disposed within the cavity of the cladding proximate to the inner surface of the cladding, each of the capillary tubes comprising (i) a longitudinal axis extending parallel to the longitudinal axis of the hollow core optical fiber, (ii) an outer surface fused to the inner surface of the cladding, and (iii) silica glass; (c) inner capillary tubes, each of the inner capillary tubes (i) nested within a different one of the capillary tubes with an outer surface of the inner capillary tube fused to an inner surface of the capillary tube and (ii) comprising a longitudinal axis extending parallel to the longitudinal axis of the hollow core optical fiber; and (d) an effective core region defined by the outer surfaces of the capillary tubes, wherein, at a temperature of 1800° C., the inner region of the cladding exhibits a viscosity that is greater than (i) a viscosity that the outer region of the cladding exhibits and (ii) a viscosity that each of the capillary tubes exhibits, wherein, the silica glasses of the inner region of the cladding, the outer region of the cladding, and the capillary tubes are each individually doped with one or more viscosity-lowering dopants, doped with one or more viscosity-raising dopants, or substantially free of both viscosity-lowering dopants and viscosity-raising dopants, wherein, each of the inner capillary tubes exhibits a softening point that is greater than or equal to a softening point that each of the capillary tubes exhibits, wherein, the softening point that each of the capillary tubes exhibits is greater than softening points that the inner region of the cladding and the outer region of the cladding exhibit, wherein, the softening point that the inner region of the cladding exhibits and the softening point that the outer region of the cladding exhibits differ by less than 5° C., wherein, the softening point that the each of the capillary tubes exhibits is at least 30° C. greater than the softening point that the outer region of the cladding exhibits, and wherein, the softening point that each of the inner capillary tubes exhibits is at least 20° C. greater than the softening point that each of the capillary tubes exhibits.

According to a seventy-first aspect of the present disclosure, the hollow core optical fiber of the seventieth aspect further comprises an outer tension absorbing layer disposed radially around the longitudinal axis of the hollow core optical fiber outward of the outer region of the cladding, the outer tension absorbing layer (i) comprising silica glass and (ii) at a temperature of 1800° C., exhibiting a viscosity that is greater than the viscosity that the outer region of the cladding exhibits and the viscosity that each of the capillary tube exhibits.

According to a seventy-second aspect of the present disclosure, the hollow core optical fiber of the seventy-first aspect is presented, wherein the outer tension absorbing layer exhibits a softening point that is at least 30° C. greater than a softening point that the outer region of the cladding exhibits.

### BRIEF DESCRIPTION OF THE DRAWINGS

In the Drawings:

FIG. 1 is a perspective view of a hollow core optical fiber of the present disclosure, illustrating the hollow core optical fiber including a first end, a second end, a longitudinal axis, and a length extending along the longitudinal axis from the first end to the second end;

FIG. 2 is an elevational view of a cross-section of the hollow core optical fiber of FIG. 1 taken through line II-II of FIG. 1, illustrating the hollow core optical fiber further including a cladding with an inner surface that forms a cavity, capillary tubes contiguous with the inner surface spatially distributed around the longitudinal axis, and an effective core region defined by the capillary tubes;

FIG. 3 is an elevational view of a cross-section of a variation of the hollow core optical fiber of FIG. 1 taken through line III-III of FIG. 1, illustrating inner capillary tubes, a different one of which is disposed within a cavity of each of the capillary tubes;

FIG. 4 is a perspective view of a hollow core optical fiber preform of the present disclosure, illustrating the hollow core optical fiber preform including a cladding with an inner surface forming a cavity through which a longitudinal axis extends, and capillary tubes proximate the inner surface within the cavity spatially arranged around the longitudinal axis;

FIG. 5 is an elevational view of a cross-section of the hollow core optical fiber preform of FIG. 4 taken through line V-V of FIG. 4, illustrating the cladding including an inner region contiguous with the inner surface, an outer region disposed further away from the longitudinal axis than the inner region, and an interfacial region disposed between the inner region and the outer region;

FIG. 6 is an elevational view of a cross-section of a variation of the hollow core optical fiber preform of FIG. 4 taken through line VI-VI of FIG. 4, illustrating inner capillary tubes, a different one of which is disposed within a cavity of each of the capillary tubes;

FIG. 7 is a flow chart of a method of manufacturing the hollow core optical fiber preform of FIG. 4 and the hollow core optical fiber of FIG. 1, illustrating a vapor deposition step, a consolidation step to form the hollow core optical fiber preform, and subsequently a drawing step to draw the hollow core optical fiber from the hollow core optical fiber preform;

FIG. 8 is a perspective view of a workpiece to be subjected to the vapor deposition step of the method of FIG. 7, illustrating the workpiece including a cladding substrate tube with an inner surface defining a cavity through which a longitudinal axis extends, capillary tubes fused to the inner surface spatially arranged around the longitudinal axis, support tubes disposed at a first end and a second end of the substrate tube closer to the longitudinal axis than the capillary tubes and fused to the capillary tubes;

FIG. 9 is an elevational view of a cross-section of the workpiece of FIG. 8 taken through line IX-IX of FIG. 8, illustrating an embodiment where the workpiece further includes inner capillary tubes, a different one of which is disposed within a cavity of each of the capillary tubes;

FIG. 10 is a schematic diagram of the vapor deposition step of the method of FIG. 7, illustrating a burner projecting a silica soot stream that deposits upon the cladding substrate tube as a silica soot coating;

FIG. 11 is a schematic diagram of the consolidation step of the method of FIG. 7, illustrating a consolidation furnace consolidating the silica soot coating of the workpiece and transforming the silica soot coating and the cladding substrate tube into the cladding of the hollow core optical fiber preform of FIG. 4, with the outer region of the cladding being derived from the silica soot coating and the inner region of the cladding being derived from the cladding substrate tube;

FIG. 12 is a schematic diagram of the drawing step of the method of FIG. 7, illustrating the hollow core optical fiber preform of FIG. 4 disposed in a draw furnace to increase the temperature of the hollow core optical fiber preform, allowing the hollow core optical fiber to be drawn therefrom and spooled onto a fiber storage spool;

FIG. 13 is a graph plotting viscosity during the drawing step of the method of FIG. 7 as a function of radius from the longitudinal axis of an embodiment of the hollow core optical fiber preform, illustrating the viscosity of each of the inner capillary tubes (if included) being greater than the viscosity of each of the capillary tubes, which is greater than the viscosity of the inner region of the cladding (derived from the cladding tube), which is greater than the viscosity of the outer region of the cladding (derived from the silica soot coating), which decreases linearly as a radius from the longitudinal axis increases;

FIG. 14 is the same type of graph as FIG. 13 but this time illustrating the inner region of the cladding having the greatest viscosity followed by, in order of descending viscosities, the inner capillary tubes, the capillary tubes, and the outer region of the cladding, the viscosity of the last of which decreases linearly as a function of increasing radius;

FIG. 15, pertaining to Example 1 and Comparative Examples 1 and 2, is a graph illustrating outer diameter of the capillary tubes as a function of (i) pressure differential (between the cavity of the capillary tubes to the cavity of the cladding) and (ii) relative viscosity difference between the capillary tubes and the cladding during the drawing step, illustrating that (i) when the viscosity of the cladding is less than the viscosity of the capillary tubes, as in Example 1, the outer diameter increases slightly linearly as a function of increasing pressure differential but (ii) when the viscosities of the cladding and capillary tubes are about equal, as in Comparative Examples 1 and 2, the outer diameter increases exponentially as a function of increasing pressure differential;

FIG. 16, pertaining to Example 2, is a scanning electron microscope image of a cross-section of a hollow core optical fiber preform of the present disclosure (except for one of the capillary tubes that broke during processing before capturing the image); and

FIG. 17, pertaining to Example 2 again, is a scanning electron microscope image of a cross-section of a hollow core optical fiber of the present disclosure drawn from the hollow core optical fiber preform depicted at FIG. 16.

### DETAILED DESCRIPTION

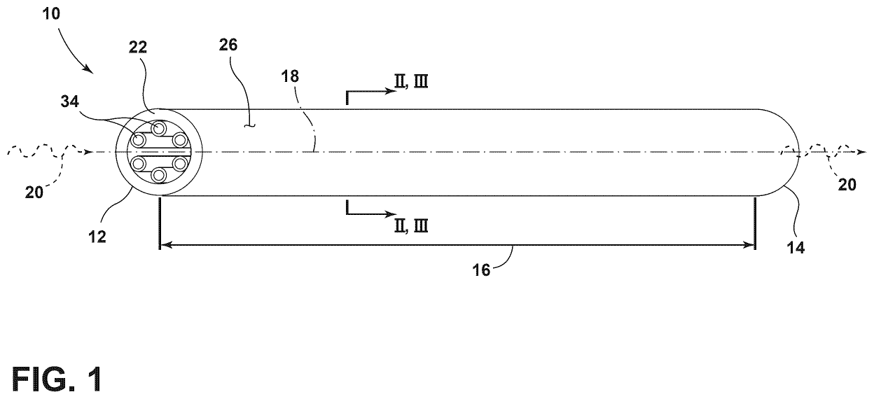

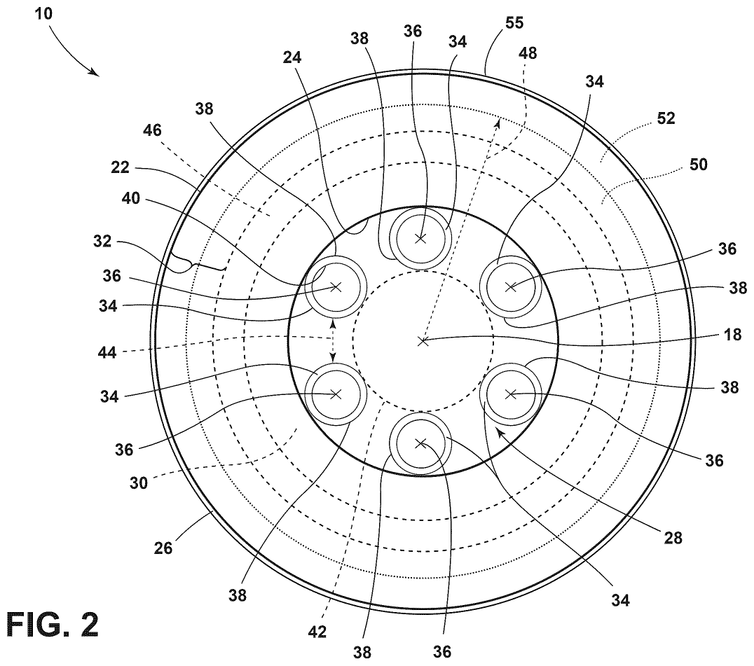

Referring now to FIGS. 1 and 2, a hollow core optical fiber 10 includes a first end 12, a second end 14, and a length 16 extending between the first end 12 and the second end 14. The hollow core optical fiber 10 further includes a longitudinal axis 18 that is the radial center of the hollow core optical fiber 10 and extends the length 16 of the hollow core optical fiber 10. In general terms, the hollow core optical fiber 10 is a waveguide that transmits electromagnetic radiation 20 that enters the first end 12, through the length 16 of the hollow core optical fiber 10, and out of the hollow core optical fiber 10 at the second end 14. The length 16 of the hollow core optical fiber 10 is not particularly limited and depends on the application. Examples of the length 16 include less than 5 mm, 5 mm, 1 cm, 1 m, 100 m, 500 m, 1 km, 1 kkm, 10 kkm, or greater than 10 kkm, or within any range bound by any two of those values (e.g., from 5 mm to 1 kkm, from 1 cm to 1 m, and so on).

The hollow core optical fiber 10 includes cladding 22. The cladding 22 is disposed radially around the longitudinal axis 18, and extends from the first end 12 to the second end 14. The cladding 22 includes an inner surface 24 and an outer surface 26. The inner surface 24 faces the longitudinal axis 18 and forms a cavity 28. The outer surface 26 is further away from the longitudinal axis 18 than the inner surface 24.

The cladding 22 further includes an inner region 30 and an outer region 32. The inner region 30 extends outward from the inner surface 24 relative to the longitudinal axis 18. The outer region 32 extends outward toward the outer surface 26 relative to the inner region 30. The inner region 30 is disposed between the outer region 32 and the inner surface 24. Both the inner region 30 and the outer region 32 extend radially around the longitudinal axis 18. Both the inner region 30 and the outer region 32 include a composition that includes silica glass. However, in embodiments, the composition of the inner region 30 includes silica glass that is undoped while the composition of the outer region 32 includes silica glass that is doped with one or more viscosity-lowering dopants (e.g., fluorine). In other embodiments, the composition of the inner region 30 includes silica glass that is doped with one or more viscosity-lowering dopants (e.g., fluorine) or one or more viscosity-raising dopants (e.g., N).

In embodiments, the silica glass of the outer region 32 of the cladding 22 is doped with fluorine as the one or more viscosity-lowering dopants at an average concentration of greater than 0.3 wt %. In embodiments, the silica glass of the outer region 32 of the cladding 22 is doped with fluorine as the one or more viscosity-lowering dopants at an average concentration of greater than 0.6 wt %. In embodiments, the silica glass of the outer region 32 of the cladding 22 is doped with fluorine as the one or more viscosity-lowering dopants at an average concentration of greater than 1.0 wt %. In embodiments, the silica glass of the outer region 32 of the cladding 22 is doped with fluorine as the one or more viscosity-lowering dopants at an average concentration that is within a range of from 0.3 wt % to 1.0 wt %. Concentrations lower than 0.3 wt % and greater than 1.0 wt % are envisioned.

The one or more viscosity-raising dopants raises the viscosity of silica glass that the one or more viscosity-raising dopants dopes. In embodiments, the one or more viscosity-raising dopants include one or more of N and ZrO₂. A particular example is doping the silica glass with N, which can form Si₃N₄. Other viscosity-raising dopants are envisioned and that list is not exhaustive. The presence of viscosity-raising dopants within the hollow core optical fiber 10 can be determined using secondary ion mass spectrometry (SIMS).

The one or more viscosity-lowering dopants lowers the viscosity of silica glass that the one or more viscosity-lowering dopants dopes. In embodiments, the one or more viscosity-lowering dopants include one or more of an alkali metal oxide, fluorine, chlorine, germania, titania, boron, and Al₂O₃. A particular example is doping the silica glass with fluorine. The presence of viscosity-lowering dopants within the hollow core optical fiber 10 can be determined using secondary ion mass spectrometry (SIMS).

The cladding 22 further includes capillary tubes 34. The capillary tubes 34 are disposed within the cladding 22 proximate to the inner surface 24 of the cladding 22. At least a portion of the capillary tubes 34 is disposed closer to the longitudinal axis 18 of the hollow core optical fiber 10 than the inner surface 24 of the cladding 22. Each of the capillary tubes 34 includes a longitudinal axis 36 that extends parallel to the longitudinal axis 18 of the hollow core optical fiber 10. In addition, each of the capillary tubes 34 includes an outer surface 38, which is fused to the inner surface 24 of the cladding 22. Further, each of the capillary tubes 34 includes an inner surface 40 at a radius 41. The inner surface 40 of any particular one of the capillary tubes 34 faces the longitudinal axis 36 thereof. Further, each of the capillary tubes 34 includes a composition that includes silica glass. The outer surfaces 38 of the capillary tubes 34 collectively define an effective core region 42 of the hollow core optical fiber 10. In use of the hollow core optical fiber 10, most of the electromagnetic radiation 20 entering the first end 12 of the hollow core optical fiber 10 propagates through the length 16 thereof within the effective core region 42 to the second end 14.

In embodiments, a distance 44 separates the outer surface 38 of adjacent capillary tubes 34. All of the distances 44 may be substantially the same. For example, the hollow core optical fiber 10 can be manufactured with the intention that all of the distances 44 are the same but there is some variation in the distances 44 due to manufacturing imperfection. In other embodiments, the outer surfaces 38 of adjacent capillary tubes 34 touch each other and may be fused together.

In embodiments, the hollow core optical fiber 10 includes from four to seven of the capillary tubes 34. For example, the hollow core optical fiber 10 can include exactly six capillary tubes 34. However, in other embodiments, the hollow core optical fiber 10 can include less than four or more than seven capillary tubes 34.

In embodiments, the cladding 22 further includes an interfacial region 46. The interfacial region 46 is disposed between the inner region 30 and the outer region 32. The interfacial region 46 is disposed closer to the longitudinal axis 18 than the outer region 32. The interfacial region 46 is disposed further from the longitudinal axis 18 than the inner region 30. The interfacial region 46 includes silica glass that is doped with the one or more viscosity-raising dopants, if present, from the inner region 30, and the one or more viscosity-lowering dopants from the outer region 32. The composition of the interfacial region 46 includes a greater percentage of the one or more viscosity-raising dopants, if present, as the position within the interfacial region 46 moves closer to the inner region 30. The composition of the interfacial region 46 includes a greater percentage of the one or more viscosity-lowering dopants as the position within the interfacial region 46 moves closer to the outer region 32.

In embodiments, concentration of the one or more viscosity-lowering dopants of the silica glass of the outer region 32 of the cladding 22 increases as radius 48 from the longitudinal axis 18 of the hollow core optical fiber 10 increases, throughout an entirety of the outer region 32. For example, in embodiments, the concentration of the one or more viscosity-lowering dopants of the silica glass of the outer region 32 of the cladding 22 is greatest at the outer surface 26 of the cladding 22. Further, in those embodiments, the concentration of the one or more viscosity-lowering dopants of the silica glass of the outer region 32 of the cladding 22 increases as a function of the radius 48 from the longitudinal axis 18 within the outer region 32. In particular examples, the concentration of the one or more viscosity-lower dopants of the outer region 32 increases linearly or parabolically as radius 48 from the longitudinal axis 18 increases, through an entirety of the outer region 32.

In embodiments, the concentration of the one or more viscosity-lowering dopants of the composition of the outer region 32 of the cladding 22 is different in a first portion 50 than the concentration is in a second portion 52. The second portion 52 of the outer region 32 is disposed further from the longitudinal axis 18 than the first portion 50. For example, the concentration of the one or more viscosity-lowering dopants is substantially constant as a function of the radius 48 from the longitudinal axis 18 of the hollow core throughout the first portion 50, while the concentration thereof changes as a function of the radius 48 from the longitudinal axis 18 throughout the second portion 52.

In embodiments, the silica glass of each of the capillary tubes 34 is substantially free of both viscosity-lowering dopants and viscosity-raising dopants (e.g., is silica glass undoped). “Substantially free” here means that the composition of the capillary tube 34 was batched without the purposeful inclusion of either a viscosity-lowering dopant or a viscosity-raising dopant and the presence, if any, in the silica glass thereafter is a trace amount (e.g., less than or equal to 0.01 wt %).

In other embodiments, the silica glass of each of the capillary tubes 34 further includes one or more viscosity-lowering dopants or one or more viscosity-raising dopants (e.g., N), in addition to the silica glass. The one or more viscosity-lowering dopants and the one or more viscosity-raising dopants can be any of those previously mentioned for the cladding 22.

In embodiments, the hollow core optical fiber 10 can exhibit characteristic relative viscosities at a temperature of 1800° C. For example, in some embodiments, the inner region 30 of the cladding 22 exhibits a viscosity that is greater than the viscosities that the outer region 32 and the cladding 22 and each of the capillary tubes 34 exhibits. Further, in those embodiments, the viscosity that each of the capillary tubes 34 exhibits is greater than the viscosity that the outer region 32 of the cladding 22 exhibits. The viscosities can be derived from the composition of the components of the hollow core optical fiber 10 (e.g., the composition of the outer region 32 of the cladding 22), through known methods, and the composition, as mentioned, can be determined via SIMS analysis. Relative concentrations of the one or more viscosity-raising dopants and the one or more viscosity-lowering dopants are predetermined to achieve the desired characteristic relative viscosities of the capillary tubes 34, the inner region 30 of the cladding 22, and the outer region 32 of the cladding 22.

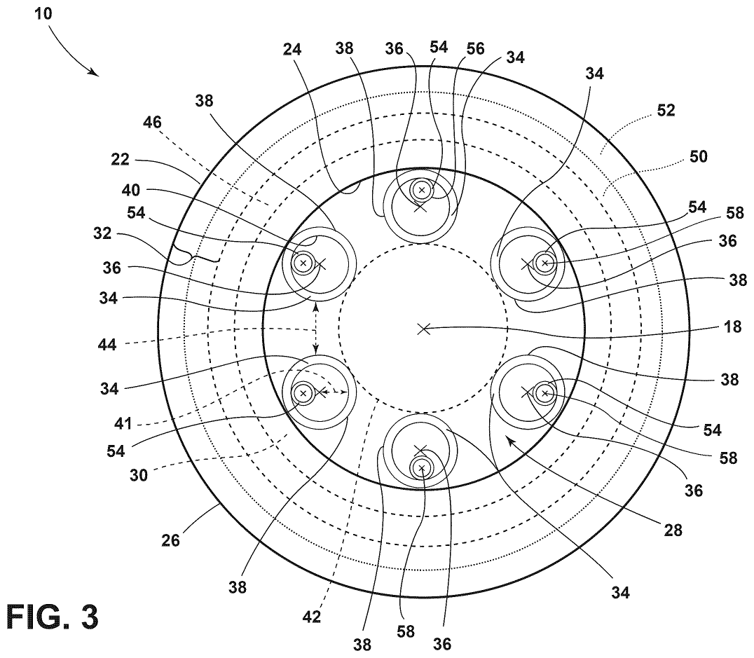

Referring now additionally to FIG. 3, in embodiments, the hollow core optical fiber 10 further includes inner capillary tubes 54. Each of the inner capillary tubes 54 is nested within a different one of the capillary tubes 34. Each of the capillary tubes 34 has one of the inner capillary tubes 54 nested therein. Each of the inner capillary tubes 54 includes an outer surface 56. For each inner capillary tube 54, the outer surface 56 thereof is fused to the inner surface 40 of the capillary tube 34 within which the inner capillary tube 54 is disposed. Further, each of the capillary tubes 34 further includes a longitudinal axis 58. The longitudinal axes 58 of the inner capillary tubes 54 extends parallel to the longitudinal axis 18 of the hollow core optical fiber 10.

Each of the inner capillary tubes 54 includes a composition. In embodiments, the compositions of each of the inner capillary tubes 54 are substantially the same (e.g., manufactured to be the same but recognizing that there is manufacturing imprecision). In more specific instances, the composition of each of the inner capillary tubes 54 includes silica glass that is substantially free of a dopant, such as a dopant that would otherwise modify the viscosity of silica glass. In other instances, the silica glass of each of the inner capillary tubes 54 includes silica glass doped with one or more viscosity-raising dopants (e.g., N) or one or more viscosity-lowering dopants (e.g., fluorine).

In embodiments, the hollow core optical fiber 10 with the inner capillary tubes 54 can exhibit characteristic relative viscosities at a temperature of 1800° C. For example, in embodiments, the inner region 30 of the cladding 22 exhibits a viscosity that is greater than the viscosities that the outer region 32 of the cladding 22 and each of the inner capillary tubes 54 exhibit. In embodiments, the viscosity that each of the inner capillary tubes 54 exhibits is greater than the viscosity that each of the capillary tubes 34 exhibits. In embodiments, the viscosity that each of the capillary tubes 34 and the viscosity that each of the inner capillary tubes 54 exhibit are greater than the viscosity that the outer region 32 of the cladding 22 exhibits. As mentioned, the viscosities can be derived from the composition of the components of the hollow core optical fiber 10, through known methods, and the composition, as mentioned, can be determined via SIMS analysis. Again, the relative concentrations of the one or more viscosity-raising dopants and the one or more viscosity-lowering dopants are predetermined to achieve the desired characteristic relative viscosities that the inner capillary tubes 54, the capillary tubes 34, the inner region 30 of the cladding 22, and the outer region 32 of the cladding 22 exhibit.

In embodiments, the hollow core optical fiber 10 further includes an outer tension absorbing layer 55. The outer tension absorbing layer 55 is disposed radially around the longitudinal axis 18 of the hollow core optical fiber 10. The outer tension absorbing layer 55 is disposed outward of the outer region 32 of the cladding 22 and can be disposed directly thereon. The outer tension absorbing layer 55 includes silica glass. The outer tension absorbing layer 55 can further include one or more viscosity-lowering dopants or one or more viscosity-raising dopants (e.g., N), in addition to the silica glass. The one or more viscosity-lowering dopants and the one or more viscosity-raising dopants can be any of those previously mentioned for the cladding 22. In embodiments, the hollow core optical fiber 10 with the outer tension absorbing layer 55 can exhibit characteristic relative viscosities at a temperature of 1800° C. For example, in embodiments, the outer tension absorbing layer 55 exhibits a viscosity that is greater than the viscosity that the outer region 32 of the cladding 22 exhibits. In addition, in embodiments, the viscosity that the outer tension absorbing layer 55 exhibits is greater than the viscosity that each of the capillary tubes 34 exhibits. In embodiments, the viscosity that the outer tension absorbing layer 55 exhibits is greater than the viscosity that the inner region 30 of the cladding 22 exhibits. In embodiments, the viscosity that the tension absorbing layer 55 exhibits is greater than equal to that of 0.9*silica. In embodiments, the thickness of the tension absorbing layer 55 (measured radially from the longitudinal axis 18) is greater than or equal to 1 mm, greater than or equal to 2 mm, or greater than or equal to 5 mm. In embodiments, the thickness of the tension absorbing layer 55 (measured radially from the longitudinal axis 18) is within a range of from 1 mm to 5 mm.

The outer tension absorbing layer 55 can reduce the axial stress that the inner region 30 of the cladding 22 exhibits, for reasons to be explained later. In embodiments, the axial stress that the inner region 30 of the cladding 22 exhibits is less than 60 MPa. In embodiments, the maximum tensile stress in the hollow core optical fiber 10 is less than 100 MPa, less than 80 MPa, less than 60 MPa, or less than 40 MPa. The stress that the inner region 30, or any other component or the hollow core optical fiber 10 generally, exhibits can be measured with an IFA-100 Multiwavelength Optical Fiber Analyzer (Interfiber Analysis, Livingston, NJ, USA). The IFA Analyzer uses transverse interferometry method to measure the refractive index distribution in the fiber and stresses in optical fibers. Details of the method to measure refractive index and stresses are described in A. D. Yablon, “Advanced Fiber Characterization Technologies for Fiber Lasers and Amplifiers”, Advanced Solid State Lasers, Shanghai, China, Nov. 16-21, 2014, which is incorporated herein in its entirety.

In embodiments, each of the capillary tubes 34 exhibits a softening point that is at least 30° C. greater than a softening point that the cladding 22 of the hollow core optical fiber 10 exhibits. As used herein, “softening point” refers to the temperature at which viscosity is 10^{7.6} Poise. In embodiments, the softening point that each of the capillary tubes 34 exhibits is at least 50° C. greater than the softening point that the cladding 22 exhibits. In embodiments, the softening point that each of the capillary tubes 34 exhibits is at least 60° C. greater than the softening point that the cladding 22 exhibits. In embodiments, the softening point that each of the capillary tubes 34 exhibits is at least 80° C. greater than the softening point that the cladding 22 exhibits. In embodiments, the softening point that each of the capillary tubes 34 exhibits is at least 100° C. greater than the softening point that the cladding 22 exhibits. In embodiments, the softening point that each of the inner capillary tubes 54 exhibits is at least 30° C., at least 50° C., at least 80° C., or at least 100° C. greater than the softening point that the cladding 22 exhibits. In embodiments, the softening point that each of the inner capillary tubes 54 exhibits is greater than (e.g., less than 20° C. greater than) the softening point that each of the capillary tubes 34 exhibits. In embodiments, the softening points that the inner region 30 and the outer region 32 of the cladding 22 exhibit differ by less than 5° C. The difference in the softening points that the cladding 22 and each of the capillary tubes 34 (and each of the inner capillary tubes 54, if present) exhibit is a function of differences in compositions between the cladding 22 and the capillary tubes 34 (e.g., the presence and relative concentrations of the one or more viscosity-raising dopants and the one or more viscosity-lowering dopants).

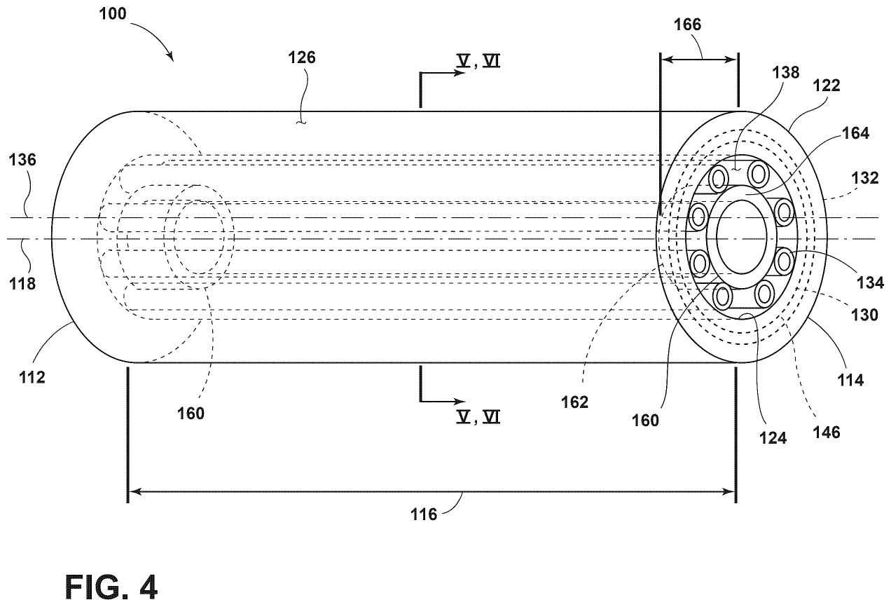

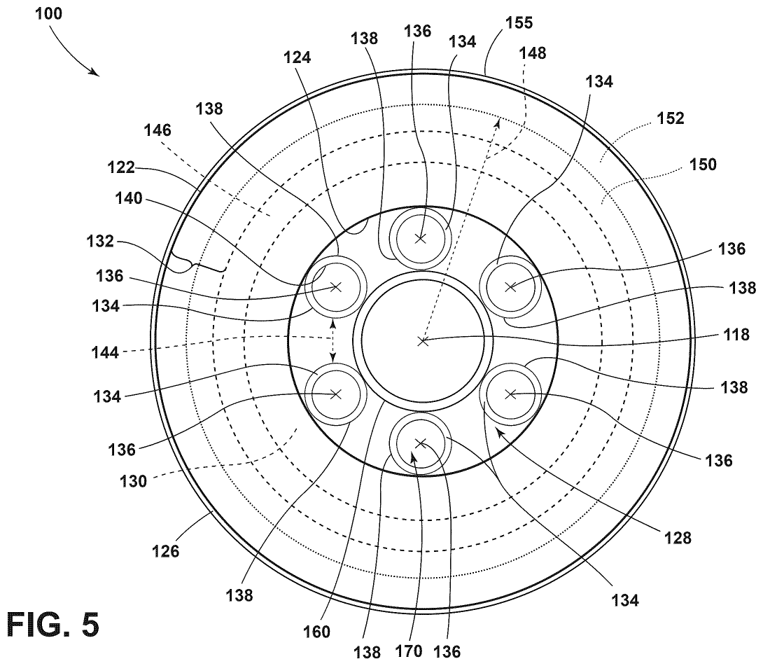

Referring now to FIGS. 4-5, a hollow core optical fiber preform 100 is herein described, from which the embodiments of the hollow core optical fiber 10 described above can be formed. Because the hollow core optical fiber 10 is formed from the hollow core optical fiber preform 100, the hollow core optical fiber preform 100 and the hollow core optical fiber 10 share like components, which are identified in the figures with like reference numbers. For example, the hollow core optical fiber preform 100 includes a cladding 122. The cladding 122 is disposed around a longitudinal axis 118 of the hollow core optical fiber preform 100. The cladding 122 extends along the longitudinal axis 118 from a first end 112 to a second end 114. The cladding 122 further includes a length 116 that is parallel to the longitudinal axis 118 and extending from the first end 112 to the second end 114. The cladding 122 further includes an inner surface 124 and an outer surface 126. The inner surface 124 faces the longitudinal axis 118. The inner surface 124 defines a cavity 128. The outer surface 126 faces away from the longitudinal axis 118.

The cladding 122 further includes an inner region 130 and an outer region 132. The inner region 130 extends outward from the inner surface 124 relative to the longitudinal axis 118. The inner region 130 extends from the first end 112 to the second end 114. The outer region 132 of the cladding 122 extends outward relative to the inner region 130 and can be contiguous with the outer surface 126 of the cladding 122. The outer region 132 extends from the first end 112 to the second end 114.

The hollow core optical fiber preform 100 further includes capillary tubes 134. The cladding 122 encircles the capillary tubes 134. The capillary tubes 134 are disposed proximate to the inner surface 124 of the cladding 122. Each of the capillary tubes 134 includes a longitudinal axis 136 that extends parallel to the longitudinal axis 118 of the hollow core optical fiber preform 100. Each of the capillary tubes 134 includes an outer surface 138 and an inner surface 140. At least a portion of the outer surface 138 of each of the capillary tubes 134 is fused to the inner surface 124 of the cladding 122. Being so fused imparts structural integrity to the components of the hollow core optical fiber preform 100 during draw of the hollow core optical fiber 10 therefrom. The inner surface 140 of each of the capillary tubes 134 defines a cavity 170.

In embodiments, the hollow core optical fiber preform 100 further includes one or more support tubes 160. The one or more support tubes 160 also impart structural integrity to the hollow core optical fiber preform 100, such as during draw of the hollow core optical fiber preform 100 therefrom. The hollow core optical fiber preform 100 includes two support tubes 160—a different one of the support tubes 160 disposed proximate the first end 112 and the second end 114 of the cladding 122 and encircled by the inner surface 124 of the cladding 122. The one or more support tubes 160 are disposed around the longitudinal axis 118 of the hollow core optical fiber preform 100—the longitudinal axis 118 extends through each of the one or more support tubes 160. The one or more support tubes 160 are disposed closer to the longitudinal axis 118 of the hollow core optical fiber preform 100 than the capillary tubes 134. The capillary tubes 134 are disposed around and outward of each of the one or more support tubes 160. The outer surface 138 of each of the capillary tubes 134 is fused to each of the one or more support tubes 160.

Each of the one or more support tubes 160 includes a first end 162, a second end 164, and a length 166. The length 166 is parallel to the longitudinal axis 118 of the hollow core optical fiber preform 100. The length 166 extends between the first end 162 and the second end 164 of the support tube 160. The length 166 of the one or more support tubes 160 combined is less than the length of the cladding 122.

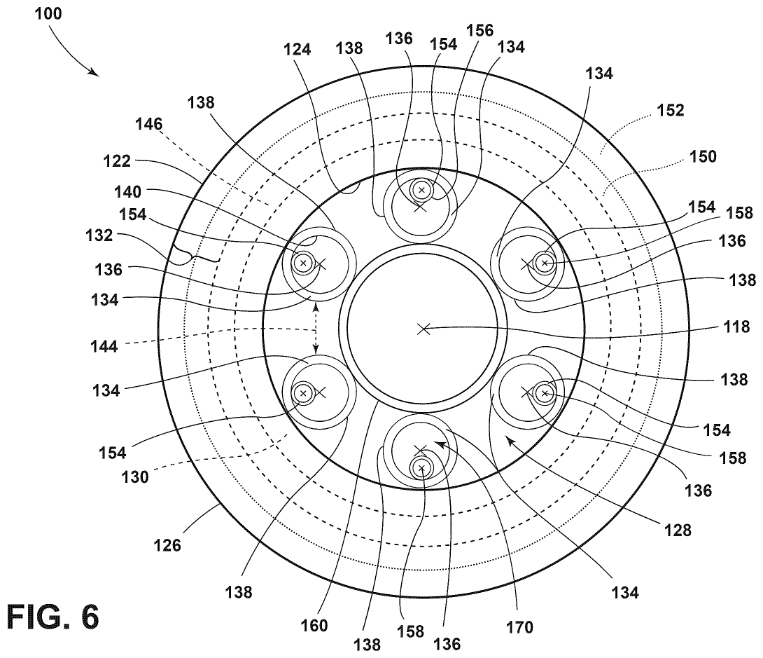

In embodiments (see, e.g., FIG. 6), the hollow core optical fiber preform 100 further includes inner capillary tubes 154. Each of the capillary tubes 134 includes a different one of the inner capillary tubes 154 disposed therein. Each of the inner capillary tubes 154 is nested within a different one of the capillary tubes 134. An outer surface 156 of each of the inner capillary tubes 154 is fused to an inner surface 140 of the capillary tube 134 within which the inner capillary tube 154 is disposed. Each of the inner capillary tubes 154 includes a longitudinal axis 158 that extends parallel to the longitudinal axis 118 of the hollow core optical fiber preform 100 and the longitudinal axis 136 of the capillary tube 134 within which the inner capillary tube 154 is disposed.

In embodiments, the hollow core optical fiber preform 100 further includes an outer tension absorbing layer 155. The outer tension absorbing layer 155 is disposed radially around the longitudinal axis 118 of the hollow core optical fiber preform 100. The outer tension absorbing layer 155 is disposed outward of the outer region 132 of the cladding 122 and can be disposed directly thereon.

The above discussion concerning the distance 44 potentially separating the outer surfaces 38 of adjacent capillary tubes 34 of the hollow core optical fiber 10 applies equally as well to a distance 144 separating the outer surfaces 138 of adjacent capillary tubes 134 of the hollow core optical fiber preform 100. The discussion concerning the number of the capillary tubes 34 of the hollow core optical fiber 10 applies equally as well to the number of the capillary tubes 134 of the hollow core optical fiber preform 100.

The above discussion concerning the composition of the inner region 30 and the outer region 32 of the cladding 22 applies equally as well to a composition of the inner region 130 and the outer region 132 of the cladding 122. The above discussion concerning the average concentration of fluorine as the one or more viscosity-lowering dopants in the silica glass of the outer region 32 of the cladding 22 apply equally as well to the outer region 132 of the cladding 122. The above discussion concerning the one or more viscosity-raising dopants and the one or more viscosity-lowering dopants of the silica glass for the various components of the hollow core optical fiber 10 applies equally as well to the various components of the hollow core optical fiber preform 100.

The discussion above concerning the interfacial region 46 of the cladding 22 of the hollow core optical fiber 10, including compositional aspects, applies equally as well to an interfacial region 146 of the hollow core optical fiber preform 100.

The discussion above concerning the concentration of the one or more viscosity-lowering dopants in the silica glass of the outer region 32 of the cladding 22, as a function of the radius 48 from the longitudinal axis 18, of the hollow core optical fiber 10, applies equally as well to the concentration of the one or more viscosity-lowering dopants in the silica glass of the outer region 132 of the cladding 122, as a function of a radius 148 from the longitudinal axis 118, of the of the hollow core optical fiber preform 100. The discussion concerning the concentration of the one or more viscosity-lowering dopants at the first portion 50 and the second portion 52 of the outer region 32 of the cladding 22 of the hollow core optical fiber 10 applies equally as well to the concentration of the one or more viscosity-lowering dopants at a first portion 150 and a second portion 152 of the outer region 132 of the cladding 122 of the hollow core optical fiber preform 100.

The discussion concerning the composition of the capillary tubes 34 and the inner capillary tubes 54 of the hollow core optical fiber 10 applies equally as well to the composition of the capillary tubes 134 and the inner capillary tubes 154 of the hollow core optical fiber preform 100. The discussion concerning the characteristic relative viscosities that the cladding 22 (including the inner region 30 and the outer region 32) and the capillary tubes 34 of the hollow core optical fiber 10 exhibit relative to each other, such as at 1800° C., applies equally as well to the viscosities that the cladding 122 (including the inner region 130 and the outer region 132) and the capillary tubes 134 of the hollow core optical fiber preform 100 exhibit relative to each other, such as at 1800° C. The discussion above concerning the relative softening points that each of the capillary tubes 34 and the cladding 22 of the hollow core optical fiber 10 exhibit applies equally as well to the capillary tubes 134 and the cladding 122 of the hollow core optical fiber preform 100. The above discussion concerning the composition, the relative softening point that the outer tension absorbing layer 55 exhibits, the viscosity that the outer tension absorbing layer 55 exhibits, and the composition of the outer tension absorbing layer 55 apply equally as well to the outer tension absorbing layer 155.

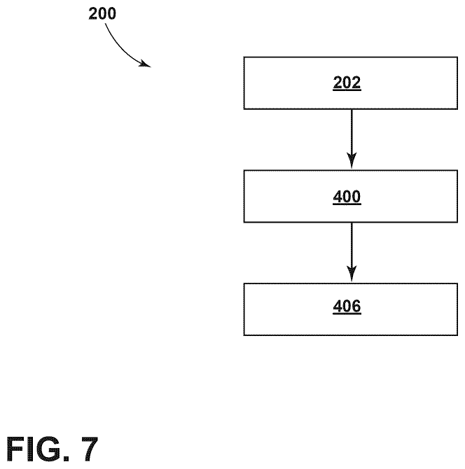

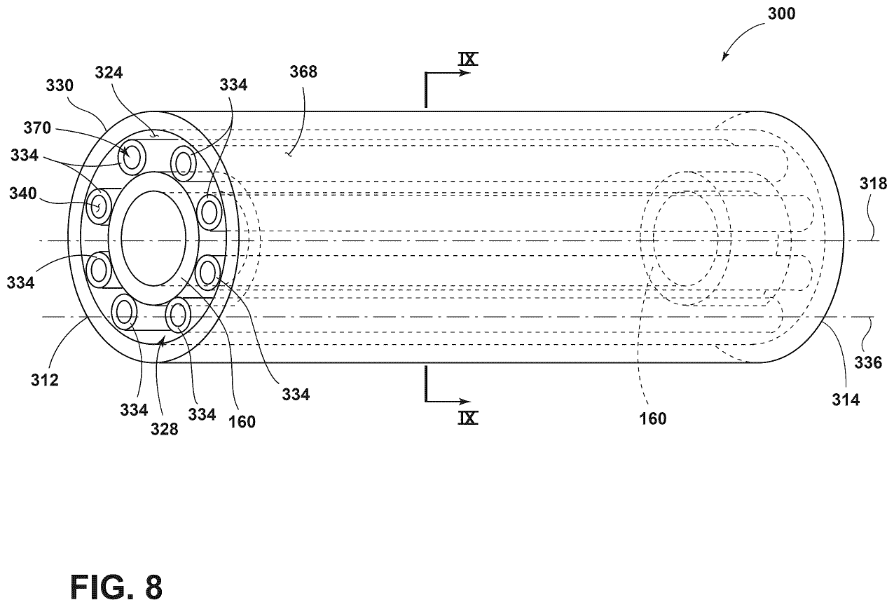

Referring now to FIGS. 7-11, a method 200 of manufacturing the hollow core optical fiber preform 100 and, subsequently, the hollow core optical fiber 10 is herein described. The method 200, at a vapor deposition step 202, includes vapor depositing a silica soot coating 204 from one or more source materials 206 over an outer surface 368 of a cladding substrate tube 330 of a workpiece 300. The cladding substrate tube 330 further includes a longitudinal axis 318 and an inner surface 324. The inner surface 324 faces the longitudinal axis 318. The outer surface 368 faces away from the longitudinal axis 118. The inner surface 324 forms a cavity 328, through which the longitudinal axis 318 extends. The cladding substrate tube 330 further includes a composition comprising silica glass, such as pure silica glass. In embodiments, the composition of the cladding substrate tube 330 further includes one or more viscosity-lowering dopants (e.g., fluorine) or one or more viscosity-raising dopants (e.g., N). Components of the workpiece 300 that are alike to components of the hollow core optical fiber 10 and the hollow core optical fiber preform 100 are identified with like reference numbers.

The workpiece 300 further includes capillary tubes 334. The capillary tubes 334 are disposed within the cavity 328 of the cladding substrate tube 330. The capillary tubes 334 are proximate the inner surface 324 of the cladding substrate tube 330. Each of the capillary tubes 334 includes a longitudinal axis 336 (only one longitudinal axis 336 is illustrated to maintain clarity of the figure). The longitudinal axes 336 of the capillary tubes 334 are parallel to the longitudinal axis 318 of the cladding substrate tube 330. Each capillary tube 334 further includes an outer surface 338 and an inner surface 340. The inner surface 340 of each capillary tube 334 forms a cavity 370. At least a portion of the outer surface 338 of each capillary tube 334 faces the inner surface 324 of the cladding substrate tube 330.

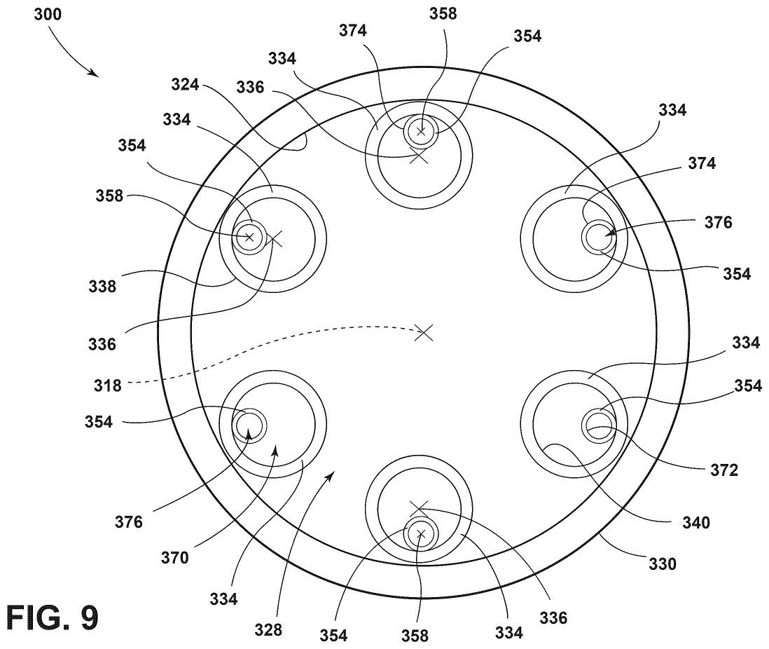

In embodiments (see FIG. 9), the workpiece 300 further includes inner capillary tubes 354. Each of the inner capillary tubes 354 is disposed within the cavity 370 of a different one of the capillary tubes 334. In addition, each of the inner capillary tubes 354 includes a longitudinal axis 358, an inner surface 372, and an outer surface 374. The inner surface 372 of each of the inner capillary tubes 354 forms a cavity 376 therein. The outer surface 374 of each of the inner capillary tubes 354 faces the inner surface 340 of the capillary tube 334 within which the inner capillary tube 354 is disposed. The discussion above concerning the compositions (e.g., silica glass doped or undoped) of the inner region 30 of the cladding 22, the capillary tubes 34, and the inner capillary tubes 54 of the hollow core optical fiber 10 apply equally as well to the compositions of the cladding substrate tube 330, the capillary tubes 334, and the inner capillary tubes 354, respectively.

The workpiece 300 can further include the support tubes 160. The capillary tubes 334 are welded or otherwise fused to the support tubes 160. In addition, the capillary tubes 334 can be welded to the substrate tube 330 to maintain the capillary tubes 334 parallel to the longitudinal axis 318 of the workpiece 300. The welding of the capillary tubes 334 to the substrate tubes 330 help overcome the problem mentioned in the Background of the capillary tubes 34 contacting and fusing to each other during draw of the hollow core optical fiber 10 from the hollow core optical fiber preform 100. The inner capillary tubes 354, if included, can be welded to the capillary tubes 334 before or after the capillary tubes 334 are inserted into the substrate tubes 330. After the assembly and welding, the workpiece 300 can be redrawn to decrease the radius of the support tubes 160, the capillary tubes 334, and the inner capillary tubes 354, if included. The vapor deposition step 202 can be performed then on this redrawn version of the workpiece 300. The welding mentioned herein can be tack welds formed via laser or flame.

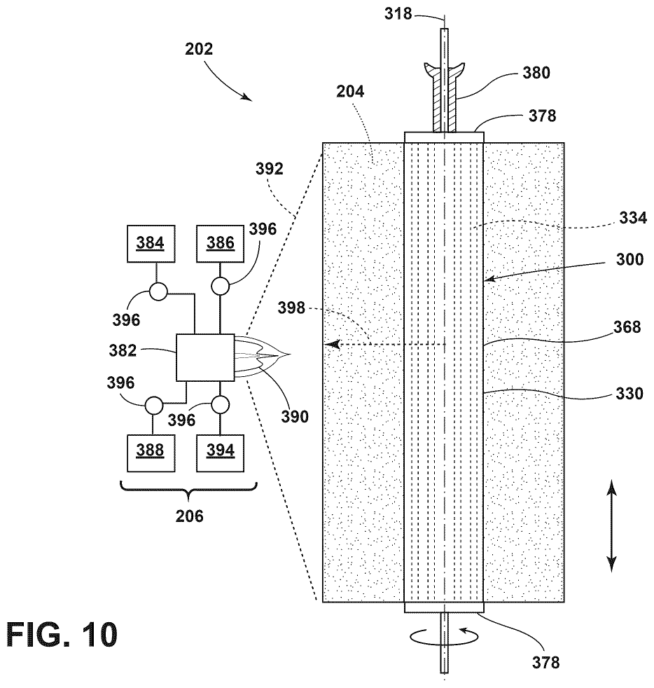

In embodiments, the vapor deposition step 202 includes an outside vapor deposition process. During outside vapor deposition of the workpiece 300, as illustrated at FIG. 10, a first end 312 and a second end 314 of the workpiece 300 are each capped with a cap 378 and a glass handle 380 is fused to one of the caps 378. The caps 378 limit or prevent silica soot from entering the cavities 328, 370 of the cladding substrate tube 330 and the capillary tubes 334. The workpiece 300 with the handle 380 is mounted in a lathe where the workpiece 300 is rotated about, and optionally translated parallel to the longitudinal axis 318 of the workpiece 300 and proximate to a burner 382. Fuel gas (e.g., methane), combustion supporting gas (e.g., oxygen), and a gaseous silica glass precursor (e.g., SiCl₄) are supplied to the burner 382 from respective sources 384-388. The mixture is burned to produce a flame 390, which is emitted from the burner 382.

The burner 382 is generally operated under conditions that will provide acceptably high laydown rates and efficiency while minimizing the buildup of the silica soot on the face thereof. Under such conditions, the flow rates of gases and reactants from the burner 382 orifices and the sizes and locations of such orifices as well as the axial orientation thereof are such that a well-focused silica soot stream 392 flows from the burner 382 toward the workpiece 300 and, in particular, the outer surface 368 of the cladding substrate tube 330. The hollow core optical fiber preform 100 is formed by traversing the workpiece 300 numerous times with respect to the burner 382 to cause a build-up of many layers of silica-containing soot to form the silica soot coating 204 on the outer surface 368 of the cladding substrate tube 330 of the workpiece 300. The translating motion could also be achieved by moving the burner 382 back and forth along the workpiece 300 as the workpiece 300 rotates or by the combined translational motion of both the burner 382 and the workpiece 300. In embodiments, the silica soot coating 204 has a composition of substantially pure silica. In embodiments, the silica soot coating 204 has a density greater than 0.35 g/cm³, such as within a range of from 0.35 g/cm³ to 0.5 g/cm³. The combination of the cladding substrate tube 330 and the silica soot coating 204 thereupon can be referred to as a cladding 322 of the workpiece 300.

Utilizing vapor deposition, and in particular outside vapor deposition, to form the silica soot coating 204, which will become part of the cladding 122 (e.g., the outer region 132) of the hollow core optical fiber preform 100, provides several advantages over other methods. Vapor deposition is less expensive than thermally collapsing sleeve tubes to form the cladding 122 of the hollow core optical fiber preform 100. In addition, vapor deposition generates the hollow core optical fiber preform 100 of larger sizes faster. Further, vapor deposition allows for precise control of the concentration of the one or more viscosity-lowering dopants within the silica soot coating 204 and thus the outer region 132 of the cladding 122 of the hollow core optical fiber preform 100.

In embodiments, during the vapor deposition step 202, source material 394 for one or more viscosity-lowering dopants is introduced into the silica-containing soot stream 392. Doped silica soot is then pyrogenically generated. The silica-containing soot stream 392 thus further includes the one or more viscosity-lowering dopants. The one or more viscosity-lowering dopants is included with the silica in the silica soot coating 204 deposited upon the workpiece 300. The one or more viscosity-lowering dopants can be any of those previously discussed. In embodiments, the source material 394 for the one or more dopants includes SiF₄ or CF₄.

In embodiments, the mass flow ratio of the source material 394 for the one or more viscosity-lowering dopants to the source material 388 for the silica is changed during the vapor deposition step 202. The fuel gas 384, the supporting gas 386, the source material 388 for the silica, and the source material 394 for the one or more viscosity-lowering dopants are all associated with a mass flow controller 396 in line before the burner 382. The mass flow controllers 396 can thus be utilized to control the relative mass flow ratios. By changing the mass flow ratio of the source material 394 for the one or more viscosity-lowering dopants to the source material 388 for the silica during the vapor deposition step 202, the composition of silica soot stream 392 can be changed and thus the composition of the silica soot coating 204 as a function of radius 398 from the longitudinal axis 318 of the workpiece 300 can be changed. For example, in embodiments, the ratio of the source material 394 of the one or more viscosity-lowering dopants to the source material 388 for the silica increases as a function of time through substantially an entirety of the vapor deposition step 202. In embodiments, the increase is linear or parabolic as a function of time. As another example, in embodiments, the ratio of the source material 394 for the one or more viscosity-lowering dopants to the source material 388 for the silica (i) is substantially constant for a first period of time and (ii) then changes throughout a second period of time (e.g., increases).

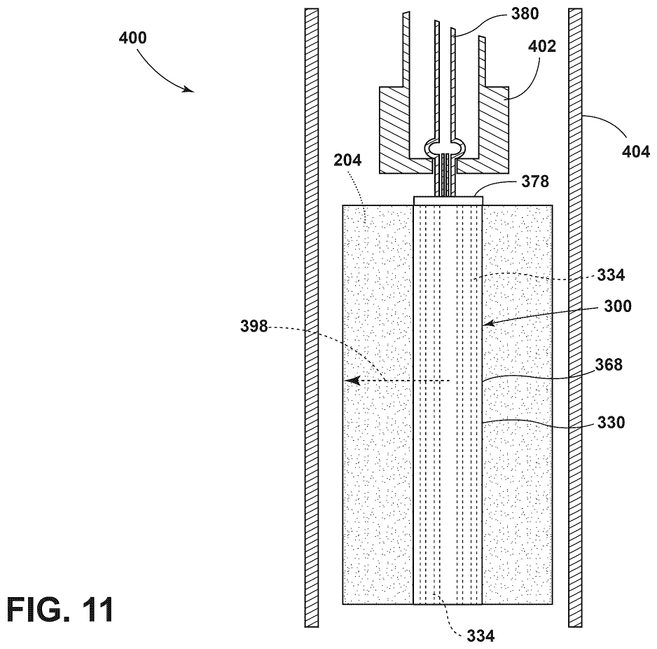

At a consolidation step 400, the method 200 further includes consolidating the silica soot coating 204. The consolidation step 400 transforms the workpiece 300 with the silica soot coating 204 into the hollow core optical fiber preform 100 discussed above (but where the composition of the cladding 122 need not yet include the one or more viscosity-lowering dopants). In embodiments, to perform the consolidation step 400, the workpiece 300 with the silica soot coating 204 can be suspended by the handle 380 upon a downfeed handle 402 and positioned within a consolidation furnace 404 (see FIG. 11).

Within the consolidation furnace 404, the workpiece 300 with the silica soot coating 204 is subjected to a temperature sufficient to consolidate the silica soot coating 204 into silica glass (e.g., from 1225° C. to 1500° C.). The silica glass of the silica soot coating 204 and the cladding substrate tube 330 of the workpiece 300 meld to become the outer region 132 and the inner region 130 respectively of the cladding 122 of the hollow core optical fiber preform 100 during the consolidation step 400. In addition, during the consolidation step 400, the density of the silica soot coating 204 increases toward, and can reach, the density of pure silica glass. Before the consolidation step 400, the silica soot coating 204 may be subjected to a chlorine-containing gas atmosphere within the consolidation furnace 404 to dry (e.g., remove water), and to remove metal impurities, from the silica soot coating 204.

Instead of (or in addition to) adding one or more viscosity-lowering dopants to the silica soot coating 204 during the vapor deposition step 202 to achieve the desired compositional (and thus viscosity) profile of the outer region 132 of the cladding 122, the consolidation step 400 can further include subjecting the silica soot coating 204 to an atmosphere that includes a gas of one or more viscosity-lowering dopants. For example, the gas can be fluorine gas or a fluorine-containing gas such as gaseous SiF₄ or fluorocarbon gasses such as CF₄, C₂F₆, and C₃F₈. The volume flow percentage of the fluorine gas or a fluorine-containing gas, as well as the temperature to which the silica soot coating 204 is subjected, can be manipulated to effectuate the desired concentration of fluorine (e.g., fluorine) within the silica soot coating 204 (and thus subsequently the cladding 122) as a function of the radius 398 from the longitudinal axis 318 of the resulting hollow core optical fiber preform 100. Suitable temperatures can be within a range of from 1000° C. to 1500° C. Suitable volume flow percentages can be within a range of from 1% to 30%. Higher flow percentages of the fluorine gas or a fluorine-containing gas result in higher desired concentration of fluorine (e.g., fluorine) within the outer region 132 of cladding 122.

In general, whether the one or more viscosity-lowering dopants are added during the vapor deposition step 202 or the consolidation step 400, the concentration of the one or more viscosity-lowering dopants as a function of the radius 398 from the longitudinal axis of the workpiece 300 can be manipulated to provide a desired viscosity profile for the hollow core optical fiber preform 100. The desired viscosity profile, in some cases, limits stresses imparted during drawing of the hollow core optical fiber 10 from the hollow core optical fiber preform 100.

In embodiments, after the consolidation step 400, the hollow core optical fiber preform 100 is subjected to another vapor deposition to apply additional silica soot thereupon, which is then consolidated again to form the outer tension absorbing layer 155 of the optical fiber preform 100. As a variation, to form the outer tension absorbing layer 155, during the vapor deposition step 202, the burners are increased in intensity to essentially consolidate a barrier layer of pure silica over the silica soot coating 204. Additional silica soot is then applied over the barrier layer. During the subsequent consolidation step 400, when the viscosity-lowering dopants are added to the silica soot coating 204, the barrier layer prevents the viscosity-lowering dopant from entering into the silica soot applied over the barrier layer. The viscosity-lowering dopant in this variation is introduced at the ends of the optical fiber preform 100 where the silica soot coating 204 is exposed and not covered by the barrier layer to the outside and the cladding substrate tube 330.

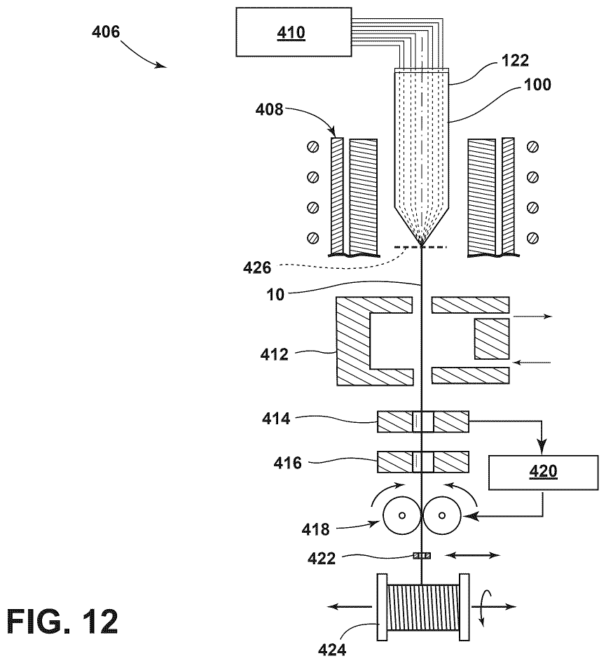

In embodiments, in further reference to FIG. 12, the method 200 further includes a drawing step 406 occurring after the consolidation step 400. In embodiments, the drawing step 406 includes subjecting the hollow core optical fiber preform 100 to a draw temperature. So subjecting the hollow core optical fiber preform 100 to the draw temperature can be accomplished by positioning the hollow core optical fiber preform 100 in a draw furnace 408 and then heating the hollow core optical fiber preform 100 using conventional methods and apparatuses.

In addition, in embodiments, the drawing step 406 includes pressuring the cavity 170 of each of the capillary tubes 134 and the cavity 128 of the cladding 122 of the hollow core optical fiber preform 100. So pressurizing can be achieved by coupling a pressure control system 410 to the cavity 170 of each of the capillary tubes 134 and the cavity 128 of the cladding 122. The pressure control system 410 can include any or all of a pressure sensor, a vacuum system, a gas pressure source, and a controller that monitors the pressure(s) within the mentioned cavities 128, 170 and uses vacuum and/or gas pressure to maintain the pressure(s) at a desired value(s). The pressure(s) within the cavities 128, 170 during the drawing step 406 at least in part determines the radii 41 of the capillary tubes 34 and the radius 48 at the inner surface 24 of the cladding 22 of the hollow core optical fiber 10.

Further, in embodiments, the drawing step 406 includes drawing the hollow core optical fiber 10 from the hollow core optical fiber preform 100. After, and as, the hollow core optical fiber preform 100 is subjected to the draw temperature, the hollow core optical fiber 10 is drawn from the hollow core optical fiber preform 100. The hollow core optical fiber 10 is then cooled in a cooling chamber 412 and measured for final diameter (two times the radius 48 at the outer surface 26) by a non-contact sensor 414. One or more coatings may be applied over the cladding 22 and cured by a coating apparatus 416.

During the drawing step 406, the hollow core optical fiber 10 passes through a tension assembly 418 whereby a draw tension is applied to draw the hollow core optical fiber 10 from the hollow core optical fiber preform 100. The draw tension is controlled via a control apparatus 420 to maintain the diameter of the hollow core optical fiber 10 at a predetermined set point. Finally, the hollow core optical fiber 10, now coated, is wound by a feedhead 422 onto a storage spool 424. In embodiments, during the drawing step 406, the draw tension while the hollow core optical fiber 10 is drawn from the hollow core optical fiber preform 100 is less than or equal to 200 grams (e.g., less than or equal to 100 grams, less than or equal to 150 grams, within a range of from 100 grams to 200 grams, within a range of from 50 grams to 100 grams, and so on).

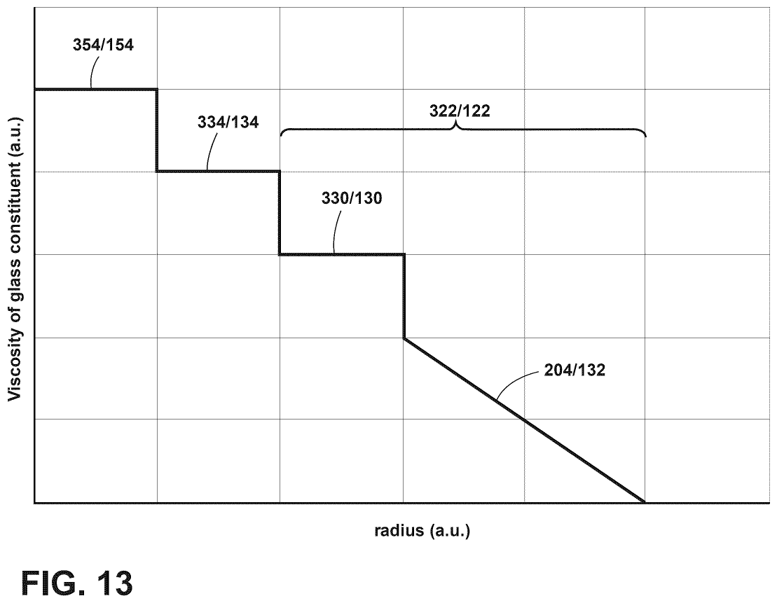

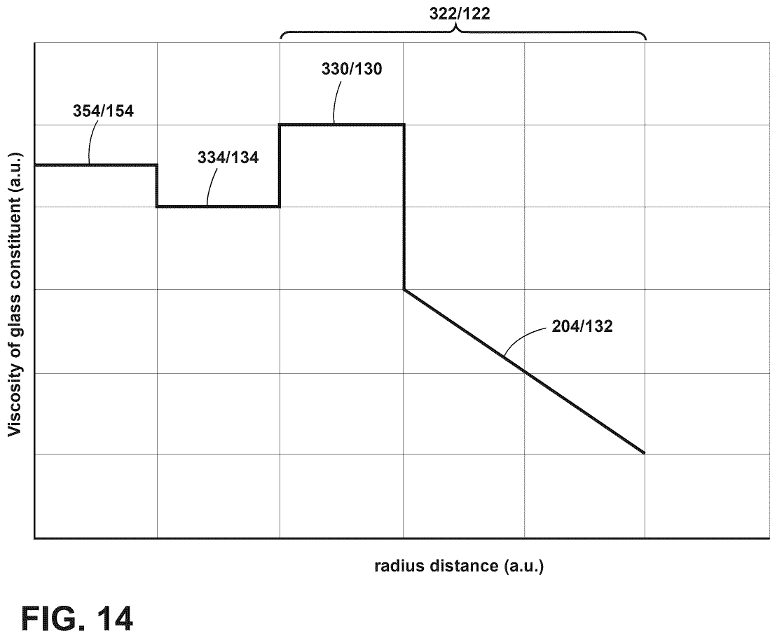

In embodiments, during the drawing step 406, at least a portion of the cladding 122 (e.g., the outer region 132 but not the inner region 130) of the hollow core optical fiber preform 100 has a viscosity that is less than a viscosity of each of the capillary tubes 134 (see, e.g., the viscosity profile of FIG. 14). In some instances, an entirety of the cladding 122 (e.g., both the inner region 130 and the outer region 132) of the hollow core optical fiber preform 100 has a viscosity that is less than a viscosity of each of the capillary tubes 134 (see, e.g., the viscosity profile of FIG. 13). The viscosities mentioned herein can be those at a horizontal plane 426 that extends through a transition region where the hollow core optical fiber preform 100 transitions to the hollow core optical fiber 10 (e.g., at a temperature of about 1200° C.). The difference between the viscosity of the cladding 122 and the viscosities of the capillary tubes 134 is a function of the difference in the compositions of the cladding 122 and the capillary tubes 134, including the presence of the one or more viscosity-raising dopants and/or the one or more viscosity-lowering dopants therein. For example, as described above, the outer region 132 of the cladding 122 of the hollow core optical fiber preform 100 can include silica glass doped with the one or more viscosity-lowering dopants (e.g., fluorine), while the composition of each of the capillary tubes 134 can include only silica glass that is not doped. In these embodiments, because the outer region 132 of the cladding 122 is a majority by mass of the hollow core optical fiber preform 100, and the viscosity of the outer region 132 of the cladding 122 is lower than the viscosity of the capillary tubes 134, the drawing temperature of the drawing step 406 can be much lower than if the outer region 132 of the cladding 122 and the capillary tubes 134 were of the same composition of silica glass undoped. Further, with the lower draw temperature, the viscosity of the capillary tubes 134 is higher than the viscosity of the outer region 132 of the cladding 122 and thus the diameter of the capillary tubes 134 is less affected by changes in pressure differential.

In embodiments, during the drawing step 406, the inner region 130 of the cladding 122 of the hollow core optical fiber preform 100 that is contiguous with the inner surface 124 of the cladding 122 of the hollow core optical fiber preform 100 exhibits a viscosity that is greater than a viscosity of the outer region 132 of the cladding 122 of the of the hollow core optical fiber preform 100 disposed outward from the inner region 130. Such viscosity profile (see, e.g., FIGS. 13 and 14) can arise where the inner region 130 of the cladding 122 is derived from the cladding substrate tube 330 of the workpiece 300, the composition of which is silica glass undoped or doped with one or more viscosity-raising dopants (e.g., N), while the outer region 132 of the cladding 122 is derived from the silica soot coating 204 that is doped with the one or more viscosity-lowering dopants (e.g., fluorine), either during the vapor deposition step 202 or the consolidation step 400).

In embodiments, during the drawing step 406, the inner region 130 of the cladding 122 of the hollow core optical fiber preform 100 extending contiguous with the inner surface 124 of the cladding 122 exhibits a viscosity that is greater than both (i) a viscosity of the outer region 132 of the cladding 122 of the hollow core optical fiber preform 100 disposed outward from the inner region 130 and (ii) viscosities of each of the capillary tubes 134 of the hollow core optical fiber preform 100. Such a difference between those viscosities can arise where (i) the inner region 130 of the cladding 122 is derived from the cladding substrate tube 330 of the workpiece 300, the composition of which is silica glass undoped or doped with one or more viscosity-raising dopants (e.g., N), (ii) the outer region 132 of the cladding 122 is derived from the silica soot coating 204 that is doped with the one or more viscosity-lowering dopants, and (iii) the compositions of each of the capillary tubes 134 likewise include silica glass doped with one or more viscosity-lowering dopants. Such a viscosity profile (see FIG. 14) can effectively prevent the outer region 132 of the cladding 122 from contacting the capillary tubes 134 during the drawing step 406. Stated another way, the inner region 130 having the greatest viscosity helps ensure that the rate of collapse of the cladding 122 generally is slow while the outer region 132 having a lesser viscosity permits the draw tension (discussed further below) to be decreased, which in turn raises the draw speed (also discussed further below).

In embodiments, during the drawing step 406, the viscosities that each of the capillary tubes 134 of the hollow core optical fiber 10 exhibits are greater than the viscosity of the outer region 132 of the cladding 122 of the hollow core optical fiber preform 100 (see, e.g., the viscosity profiles of FIGS. 13 and 14). Such a difference in those viscosities can arise where the outer region 132 of the cladding 122 is derived from the silica soot coating 204 that is doped with the one or more viscosity-lowering dopants, while the compositions of each of the capillary tubes 134 are either silica glass undoped or silica glass doped with one or more viscosity-lowering dopants but to a lesser extent than the outer region 132 of the cladding 122. When the viscosity of the outer region 132 is less than the viscosity of the capillary tubes 134, the draw temperature and the draw tension can be reduced and yet the effect of pressure on the radius of the capillary tubes 134 remains in the linear regime, meaning that any change in pressure (e.g., as measured by the pressure control system 410) can be remedied relatively easily. Without being bound by theory, it is believed that is so because the draw tension affects the capillary tubes 134 more than the outer region 132 of the cladding 122 because the viscosity of the former is greater than the latter. Because the draw tension can be reduced, the draw speed can be increased.

In embodiments, during the drawing step 406, the viscosity that the outer region 132 of the cladding 122 of the hollow core optical fiber preform 100 exhibits (i) is substantially constant throughout the first portion 150 and (ii) changes as a function of radius 148 from the longitudinal axis 118 of the hollow core optical fiber preform 100 throughout the second portion 152, the second portion 152 being further from the longitudinal axis 118 than the first portion 150. Such a viscosity profile of the outer region 132 can arise when the concentration of the one or more dopants is manipulated to be constant at the first portion 150 but then is manipulated to increase (e.g., linearly or parabolically) at the second portion 152.

In embodiments, during the drawing step 406, the viscosity that the outer region 132 of the cladding 122 of the hollow core optical fiber 100 exhibits decreases as the radius 148 from the longitudinal axis 118 of the hollow core optical fiber preform 100 increases, throughout an entirety of the outer region 132. Such a viscosity profile (see, e.g., FIGS. 13 and 14) of the outer region 132 can arise when the concentration of the one or more viscosity-lowering dopants is manipulated to increase as a function of the radius 148 from the longitudinal axis 118.

In embodiments, during the drawing step 406, the hollow core optical fiber 10 is drawn from the hollow core optical fiber preform 100 at a draw speed of greater than or equal to 1 m/s. For example, the draw speed can be greater than or equal to 5 m/s, or even greater than or equal to 10 m/s. As mentioned, the present disclosure permits relatively low draw tension, which allows for faster draw speeds. In embodiments, the draw speed is within a range of from 1 m/s to 20 m/s.

To at least partially summarize, the present disclosure addresses the problems described in the Background in several ways. Among those, instead of relying on increased draw tension to maintain the integrity of the diameter of the capillary tubes 134 (e.g., twice the radius 148 from the longitudinal axis 118 at the outer surface 126) in response to pressure changes during the drawing step 406, the present disclosure relies upon viscosity profiles as a function of the radius 148 from the longitudinal axis 118 to do so. More particularly, the composition of the outer region 132 of the cladding 122 of the hollow core optical fiber preform 100 is manipulated so that the viscosity thereof is less than the inner region 130 of the cladding 122 and the capillary tubes 134. The viscosity of the outer region 132 of the cladding 122, being lower, results in a lower draw temperature. The viscosity of capillary tubes 134, being higher, results in the diameter of the capillary tubes 134 being less responsive to changes in pressure differential during the drawing step 406. Because the diameter is less responsive, the draw tension can be reduced. Because the draw tension can be reduced, the draw speed can be increased and cabling of the hollow core optical fiber 10 is eased. Because the draw speed can be increased, the length 16 of the hollow core optical fiber 10 that can be drawn during the drawing step 406 can be increased, which makes the hollow core optical fiber 10 more commercially acceptable. In addition, the viscosity of the inner region 130 of the cladding 122 being greater than the viscosity of the outer region 132 of the cladding 122 prevents the capillary tubes 134 from contacting each other during the drawing step 406.

In embodiments where the hollow core optical fiber preform 100 includes the outer tension absorbing layer 155, the outer tension absorbing layer 155 exhibits a viscosity during the drawing step 406 that can be the same or about the same (e.g., slightly higher) as the viscosity that the inner region 130 of the cladding 122 exhibits. With the viscosities about the same or the same, but the outer tension absorbing layer 155 having a larger cross-sectional area than the inner region 130 (due to the larger diameter), the tension during the drawing step 406 is felt mostly by the outer tension absorbing layer 155 and not the inner region 130. That results in the inner region 30 of the resulting optical fiber 10 exhibiting an axial stress that is reduced in comparison to the same optical fiber 10 without the outer tension absorbing layer 55. The interface between the capillary tubes 34, 134 and the inner region 30, 130 has potential for reliability challenges due to high stresses that are induced during the drawing of the hollow core optical fiber 10. These stresses are induced due to the viscosity and thermal expansion coefficient differences between different regions of the optical fiber 10. Use of the relatively higher viscosity tension absorbing layer 55, 155 results in the layer carrying bulk of the tension load applied during the drawing step 406, thereby reducing the stresses in the other regions of the hollow core optical fiber 10, including the interfaces in the hollow core optical fiber 10 that are susceptible to failure due to high stresses.

### EXAMPLES

### Example 1 and Comparative Examples 1 and 2

For Example 1 and Comparative Examples 1 and 2, the outer diameter of capillary tubes of a hollow core optical fiber preform was calculated as a function of the pressure difference ΔP between the cavity and the capillary tube and viscosities of the cladding and the capillary tubes during draw. Comparative Example 1 assumed that both the cladding and the capillary tubes had compositions of pure (e.g., undoped) silica glass. The viscosity of pure silica glass can be approximated by μ=5.8×10⁻⁸exp(515400/8.314T) where T is the temperature of draw. Comparative Example 2 assumed that both the cladding and the capillary tubes had compositions of silica glass doped with fluorine. When the silica glass is doped with fluorine, the viscosity during draw drops to approximately 5.4×10⁻⁸exp(488000/8.314T) The doping thus results in a reduction of viscosity by ˜5.3 times and lowers the draw tension by similar amounts, because draw tension (τ) in an optical fiber is given by the equation τ=3μ(dw/dz)π(Rₒᵤₜ²−Rᵢₙ²) with μ as the viscosity, and w is the speed of the optical fiber along fiber draw dimension (z). Rₒᵤₜ and Rᵢₙ are the outside and inside radius of the, respectively, of the region of the fiber having viscosity μ. Example 1 assumed that the capillary tubes had a composition of silica glass undoped while the cladding had a composition of silica glass doped with fluorine.

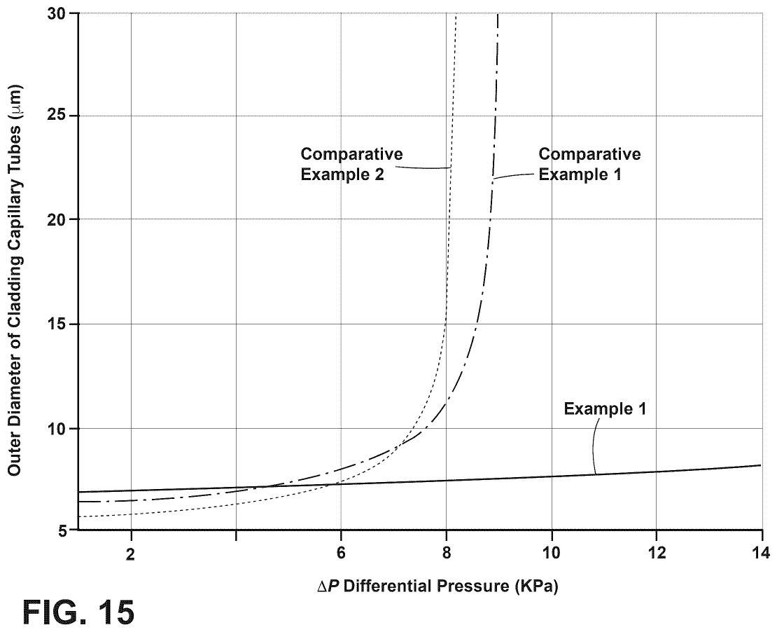

The results of the calculations are plotted on the graph reproduced at FIG. 15, which shows the dependence of the outer diameter of capillary tubes in the cladding (vertical axis) as a function of the pressure difference ΔP (horizontal axis). The graph reveals that when the capillary tubes and the cladding share the same composition (as in Comparative Examples 1 and 2), after about a pressure differential ΔP of 6 KPa, any further small change in pressure differential causes the diameter (twice the radius) of the capillary tubes to increase exponentially. Increasing the draw tension during the drawing step can help decrease the sensitivity of diameter expansion to increased pressure differential. However, as mentioned, increasing draw tension introduces other problems and thus is not an optimal solution.

However, when the silica glass of the cladding is doped with one or more viscosity-lowering dopants (e.g., fluorine) and the silica glass of the capillary tubes remains undoped, the diameter of the capillary tubes continues to change linearly as a function of pressure differential increasing, even at higher pressure differentials. The linear response makes the diameter of the capillary tubes easier to control in response to changing pressure differential during the drawing step.

### Example 2

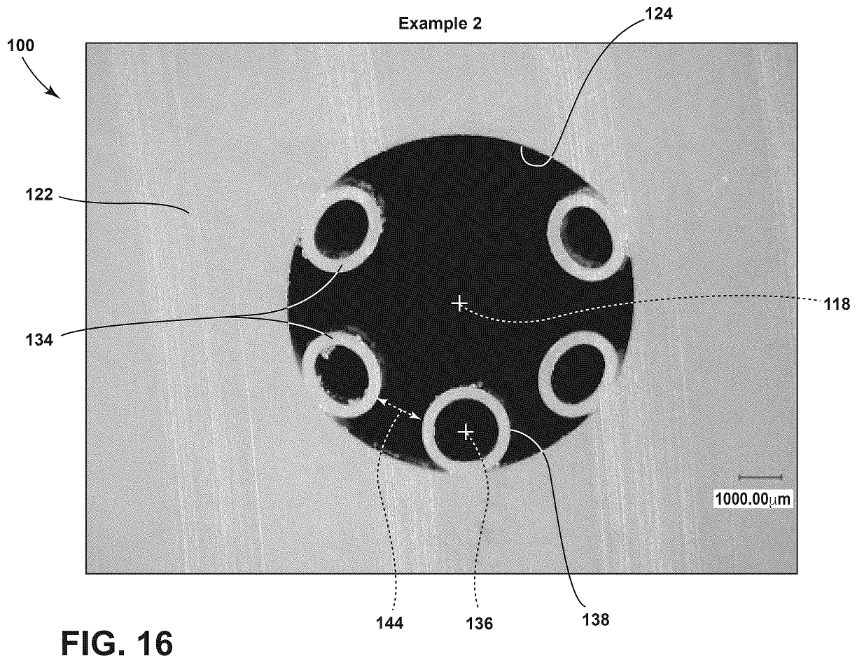

For Example 2, a hollow core optical fiber preform of the present disclosure was made according to the method of the present disclosure. The hollow core optical fiber preform was cross-sectioned, and an electron scanning microscope image was captured. The image is reproduced as FIG. 16. The outer region 32 of the cladding, derived from the silica soot coating, had a composition of silica glass doped with fluorine to reduce viscosity thereof, while the inner region of the cladding, derived from the substrate tube, and the capillary tubes all had a composition of silica glass undoped.

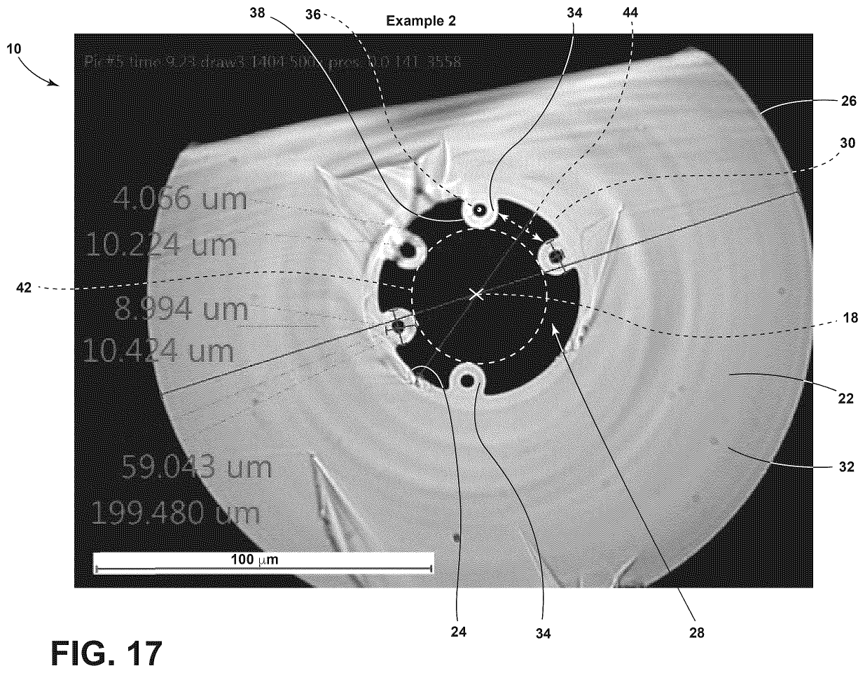

A hollow core optical fiber was drawn from the hollow core optical fiber preform. The hollow core optical fiber was cross-sectioned, and an electron scanning microscope image was captured. The image is reproduced as FIG. 17.

One of the capillary tubes was damaged during handling of the hollow core optical fiber preform and thus is missing from the images of FIGS. 16 and 17. However, the image of FIG. 17 reveals the capillary tubes remaining separated during the drawing step and thus no contact therebetween during the drawing step. The lack of contact during the drawing step can be attributed to the inner region of the cladding having a viscosity higher than a viscosity of the outer region of the cladding.

What is claimed is:

1. A hollow core optical fiber or hollow core optical fiber preform comprising:
a cladding disposed radially around a longitudinal axis of the hollow core optical fiber or hollow core optical fiber preform, the cladding extending along the longitudinal axis from a first end to a second end and comprising (i) an inner surface forming a cavity, (ii) an inner region extending outward from the inner surface relative to the longitudinal axis, the inner region comprising silica glass, and (iii) an outer region extending outward relative to the inner region, the outer region comprising silica glass;
capillary tubes disposed within the cavity of the cladding proximate to the inner surface of the cladding, each of the capillary tubes comprising (i) a longitudinal axis extending parallel to the longitudinal axis of the hollow core optical fiber or hollow core optical fiber preform, (ii) an outer surface fused to the inner surface of the cladding, and (iii) silica glass; and
an effective core region defined by the outer surfaces of the capillary tubes,
wherein, at a temperature of 1800° C., the inner region of the cladding exhibits a viscosity that is greater than (i) a viscosity that the outer region of the cladding exhibits and (ii) a viscosity that each of the capillary tubes exhibits, and
wherein, the silica glasses of the inner region of the cladding, the outer region of the cladding, and the capillary tubes are each individually doped with one or more viscosity-lowering dopants, doped with one or more viscosity-raising dopants, or substantially free of both viscosity-lowering dopants and viscosity-raising dopants.

2. The hollow core optical fiber or hollow core optical fiber preform of claim 1, wherein the one or more viscosity-raising dopants is chosen from a group consisting of N and ZrO₂ and the one or more viscosity-lowering dopants is chosen from a group consisting of an alkali metal oxide, fluorine, chlorine, germania, titania, boron, and Al₂O₃.

3. The hollow core optical fiber or hollow core optical fiber preform of claim 1, wherein a distance separates the outer surfaces of adjacent capillary tubes.

4. The hollow core optical fiber or hollow core optical fiber preform of claim 1, wherein the cladding further comprises an interfacial region disposed between the inner region and the outer region, the interfacial region comprising silica glass that is doped with both the one or more viscosity-raising dopants and the one or more viscosity-lowering dopants.

5. The hollow core optical fiber or hollow core optical fiber preform of claim 1, wherein
the silica glass of the outer region of the cladding is doped with the one or more viscosity-lowering dopants, and
the concentration of the one or more viscosity-lowering dopants doping the silica glass of the outer region of the cladding increases as radius from the longitudinal axis of the hollow core optical fiber increases, throughout an entirety of the outer region.

6. The hollow core optical fiber or hollow core optical fiber preform of claim 1, wherein
the silica glass of the outer region of the cladding is doped with the one or more viscosity-lowering dopants, and
the concentration of the one or more viscosity-lowering dopants doping the silica glass of the outer region of the cladding (i) is substantially constant as a function of radius from the longitudinal axis of the hollow core optical fiber throughout a first portion and (ii) changes as a function of radius from the longitudinal axis of the hollow core optical fiber throughout a second portion, the second portion being further from the longitudinal axis than the first portion.

7. The hollow core optical fiber or hollow core optical fiber preform of claim 1, wherein the silica glass of the capillary tubes is substantially free of both the viscosity-lowering dopants and the viscosity-raising dopants.

8. The hollow core optical fiber or hollow core optical fiber preform of claim 1, wherein the silica glass of each of the capillary tubes is doped with the one or more viscosity-lowering dopants.

9. The hollow core optical fiber or hollow core optical fiber preform of claim 1, wherein at the temperature of 1800° C., the viscosities of each of the capillary tubes are greater than the viscosity that the outer region of the cladding exhibits.

10. The hollow core optical fiber or hollow core optical fiber preform of claim 1 further comprising:
inner capillary tubes, each of the inner capillary tubes (i) nested within a different one of the capillary tubes with an outer surface of the inner capillary tube fused to an inner surface of the capillary tube and (ii) comprising a longitudinal axis extending parallel to the longitudinal axis of the hollow core optical fiber.

11. The hollow core optical fiber or hollow core optical fiber preform of claim 1, wherein each of the capillary tubes exhibits a softening point that is at least 30° C. greater than a softening point that the cladding exhibits.

12. The hollow core optical fiber or hollow core optical fiber preform of claim 1, wherein the silica glass of the outer region of the cladding is doped with fluorine as the one or more viscosity-lowering dopants at an average concentration of greater than 0.3 wt %.

13. A method of manufacturing a hollow core optical fiber comprising:
with a workpiece comprising: (a) a cladding substrate tube comprising (i) a longitudinal axis, (ii) an inner surface forming a cavity, (iii) an outer surface, and (iv) silica glass and (b) capillary tubes disposed within the cavity of the cladding substrate tube proximate the inner surface of the cladding substrate tube, each of the capillary tubes comprising (i) a longitudinal axis parallel to the longitudinal axis of the cladding substrate tube, (ii) an inner surface forming a cavity, and (iii) silica glass, and
a vapor deposition step comprising vapor depositing a silica soot coating from one or more source materials over the outer surface of the cladding substrate tube.

14. The method of claim 13, wherein the workpiece further comprises inner capillary tubes, each of which is disposed within the cavity of a different one of the capillary tubes, each of the inner capillary tubes comprising (i) a longitudinal axis parallel to the longitudinal axis of the cladding substrate tube, (ii) an inner surface forming a cavity, and (iii) silica glass.

15. The method of claim 13, wherein during the vapor deposition step, source material for silica glass is vaporized and oxidized to form a silica-containing soot stream that is directed to the workpiece to form a preform that comprises the workpiece with a silica soot coating.

16. The method of claim 15, wherein
during the vapor deposition step, source material for one or more viscosity-lowering dopants is vaporized and introduced into the silica-containing soot stream that is directed to the workpiece, and
the silica soot coating further comprises the one or more viscosity-lowering dopants.

17. The method of claim 16, wherein a mass flow ratio of the source material for the one or more viscosity-lowering dopants to the source material for the silica glass is changed during the vapor deposition step.

18. The method of claim 16, wherein the ratio of the source material for the one or more viscosity-lowering dopants to the source material for the silica glass increases as a function of time throughout substantially an entirety of the vapor deposition step.

19. The method of claim 13 further comprising:
a consolidation step comprising consolidating the soot preform, thus forming a hollow core optical fiber preform comprising:
a cladding disposed radially around a longitudinal axis of the hollow core optical fiber preform, the cladding extending along the longitudinal axis from a first end to a second end and comprising (i) an inner surface and (ii) silica glass; and
capillary tubes disposed within the cladding proximate to the inner surface of the cladding, each of the capillary tubes comprising (i) a longitudinal axis extending parallel to the longitudinal axis of the hollow core optical fiber preform, (ii) an outer surface fused to the inner surface of the cladding, and (iii) silica glass.

20. The method of claim 13 further comprising:
a drawing step comprising (i) subjecting the hollow core optical fiber preform to a draw temperature, (ii) pressurizing the cavity of each of the capillary tubes and the cavity of the cladding, and (iii) drawing a hollow core optical fiber from the hollow core optical fiber preform.
